(19) United States
(12) Patent Application Publication
(10) Pub. No.: US 2025/0200481 A1
(43) Pub. Date: Jun. 19, 2025

(54) SYSTEMS AND METHODS FOR PERFORMANCE INDICATOR OPERATIONS UTILIZING MODELED ACTIVITIES OF USERS

(71) Applicant: Wells Fargo Bank, N.A., San Francisco, CA (US)

(72) Inventor: Justin Morris Krieger, San Francisco, CA (US)

(73) Assignee: Wells Fargo Bank, N.A., San Francisco, CA (US)

(21) Appl. No.: 18/541,521

(22) Filed: Dec. 15, 2023

(51) Int. Cl. G06Q 10/0639

(52) U.S. Cl. CPC G06Q 10/0639

(57) ABSTRACT

Systems, methods, and computer-readable storage media for performance indicator operations are disclosed. One method includes receiving activity data of a user, wherein the activity data comprises a plurality of dimensions. The method further includes modeling the activity data utilizing one or more weights applied to the plurality of dimensions to generate a performance indicator of the user. The method further includes determining at least one action corresponding to updating the performance indicator. The method further includes generating and providing a graphical user interface (GUI) comprising an actionable element and at least one graphical representation of the performance indicator, wherein the actionable element is associated with the at least one action.

### TECHNICAL FIELD

The present disclosure relates generally to the field of performance analysis and content customization and presentation, including monitoring activities of users and providing users with actionable alerts to modify credit utilization.

### BACKGROUND

In a computer networked environment such as the internet, entities such as people or companies provide content for display associated with a performance with the entity. Entities that provide the content may desire to provide actionable content corresponding to performance indicators.

### SUMMARY

One embodiments relates to a system. The system includes a processing circuit including memory and one or more processors, the processing circuit configured to receive activity data of a user, wherein the activity data includes a plurality of dimensions. The processing circuit further configured to model the activity data utilizing one or more weights applied to the plurality of dimensions to generate a performance indicator of the user. The processing circuit further configured to determine at least one action corresponding to updating the performance indicator. The processing circuit further configured to generate and provide a graphical user interface (GUI) including an actionable element and at least one graphical representation of the performance indicator, wherein the actionable element is associated with the at least one action.

Some embodiments relates to a method. The method includes receiving, by one or more processing circuits, activity data of a user, wherein the activity data includes a plurality of dimensions. The method further includes modeling, by the one or more processing circuits, the activity data utilizing one or more weights applied to the plurality of dimensions to generate a performance indicator of the user. The method further includes determining, by the one or more processing circuits, at least one action corresponding to updating the performance indicator. The method further includes generating and providing, by the one or more processing circuits, a graphical user interface (GUI) including an actionable element and at least one graphical representation of the performance indicator, wherein the actionable element is associated with the at least one action.

Some embodiments relate to one or more non-transitory computer-readable storage media having instructions stored thereon that, when executed by at least one processing circuit, causes the at least one processing circuit to receive activity data of a user, wherein the activity data includes a plurality of dimensions, model the activity data utilizing one or more weights applied to the plurality of dimensions to generate a performance indicator of the user, determine at least one action corresponding to updating the performance indicator, and generate and provide a graphical user interface (GUI) including an actionable element and at least one graphical representation of the performance indicator, wherein the actionable element is associated with the at least one action.

### BRIEF DESCRIPTION OF THE DRAWINGS

FIG. 1 is a block diagram of an activity modeler architecture including an analysis system, according to example embodiments.

FIG. 2 is a block diagram illustrating an example computing system suitable for use in the example embodiments described herein.

FIG. 3 is a flow diagram of a method for modeling activities of a user to generate actions to update a performance indicator, according to example embodiments.

FIG. 4A is an illustration of a configuration of a user interface generated by the analysis system of FIG. 1, according to example embodiments.

FIG. 4B is an illustration of an additional configuration of a user interface generated by the analysis system of FIG. 1, according to example embodiments.

FIG. 4C is an illustration of an additional configuration of a user interface generated by the analysis system of FIG. 1, according to example embodiments.

FIG. 4D is an illustration of an additional configuration of a user interface generated by the analysis system of FIG. 1, according to example embodiments.

FIG. 4E is an illustration of an additional configuration of a user interface generated by the analysis system of FIG. 1, according to example embodiments.

### DETAILED DESCRIPTION

Referring generally to the Figures, the systems and methods described herein relate to modeling activities and performance of a user to generate performance indicator improvement actions. The systems and methods described herein generally relate to analyzing a user's activity data and determining steps to improve their performance indicator. In typical systems, a computing device can present a variety of content (e.g., within the viewpoint of the computing device) relating to compartmentalized and often stale performance of the user. The systems and methods described herein generally relate to modeling current and previous activity and performance of the user to generate performance indicator improvement actions achievable within a single click, slide, swipe, or action by the user. Oftentimes, users may not qualify for certain performance products at a specific point in time. In many systems, they cannot predict if the user may qualify for the performance product at a future point in time if the users performs one or more actionable activities or events. Thus, the present disclosure relates to accurately modeling current and past activity and performance of the user to generate customized performance indicator improvement actions the users could act upon in the near future.

Additionally, in some systems regarding performance, the entity can be presented with a performance indicator that is days, weeks, months, or years old. Having a performance indicator that is not based on current interaction data can lead to an entity's reliance on a non-current performance indicator, leading to a decision or lack of decision-making that can affect a future performance, adversely affecting an entity's profile and their knowledge thereof. Accordingly, the present disclosure is directed to systems and methods for generating, providing, and presenting a real-time (or near real-time), holistic view of a user's performance indicator (e.g., current economic credit position, account status, etc.). The user's performance indicator can then be used to generate performance indicator improvement actions and predict future performance indicator enhancements. The present disclosure is aimed at improving both usability and data security, ensuring customer protected data (e.g., transaction data, financial data, account data) stays within the purview of operating providers (e.g., credit reporting agencies) while still providing insights to the user. That is, the systems and methods mitigate the need to share this sensitive data across providers, thereby further enhancing data security.

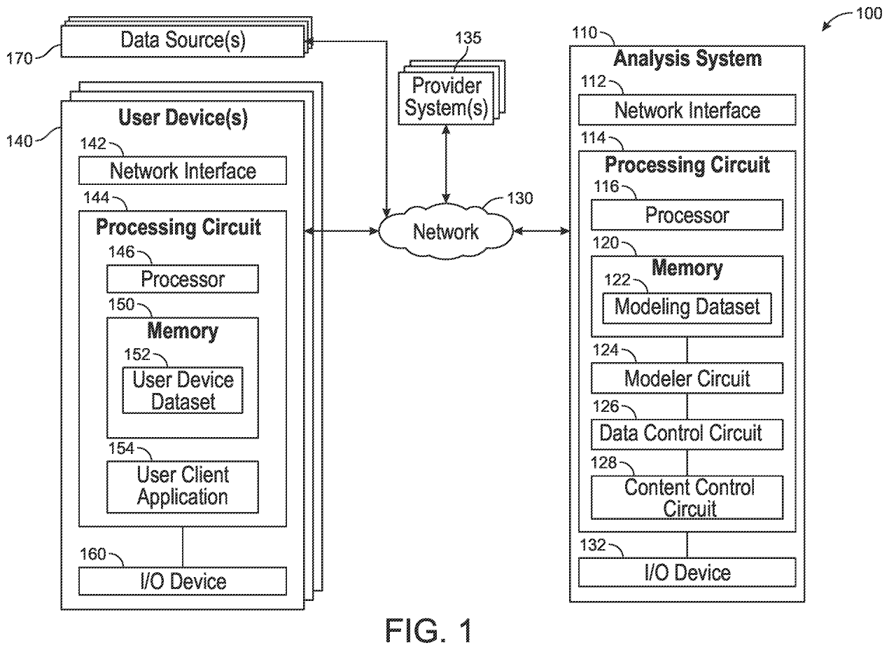

Moreover, the present disclosure is directed towards improvements in existing forecasting architectures. The present disclosure enhances the precision of data analysis by using a predictive model to generate performance indicator improvement actions and projected future performance indicators of users. The predictive model of the present disclosure improves existing systems by accurately anticipating future activities and potential actions to achieve one or more performance indicators based on a predictive model that adapts to each customer's activity and habits. The present disclosure is directed towards capabilities that go beyond providing a performance indicator improvement actions at the present time by using a predictive model capable of dynamically generating real-time or near real-time performance indicator improvement actions that user can take (e.g., oftentimes initiated and performed by the system, such as the analysis system of FIG. 1) immediately to improve one or more performance indicators.

Furthermore, the systems and methods of the present disclosure are directed towards improvements to economic tools that are generally passive. The present disclosure provides for active systems capable of generating actionable actions and monitoring potential un-advantageous situations to provide an active personalized tool to reduce potential negative events associated with a customer or provider institutions and improve product utilization of a provider. The customized system of the present disclosure is individualist and provides improvements to data validation and extraction processes. Additionally, the user specific graphical user interfaces provide the end user with control over improving their performance indicator using a single click, slide, swipe, or action, providing an improved user interface. Therefore, aspects of the present disclosure also address problems in content presentation by providing improved presentation technology for the presentation of content on computer devices. In particular, the present disclosure addresses the technical challenges in interfacing by presenting personalized content. In one example, one or more processing circuits of the electronic devices can determine the amount of use of each task and indicators over a period of time and determine how much memory has been allocated to various tasks and indicators over a period of time (e.g., analysis system tracking memory usage for incoming activity data and the effects on performance indicators or future performance indicators over a period of a time, and potential options to automatically increase a performance indicator using a single action) such that adjustments to the user interface can be done in real-time (e.g., end high memory usage processes, allocate more memory usage to certain processes, enable more memory for usage, and so on).

An additional technical improvement described herein encompasses the system's capability to conduct deep semantic analysis on user activity data. This allows the system to not just rely on quantitative data but also to extract qualitative insights from user interactions. By understanding the context and nuances of user activity, the systems and methods disclosed herein can model activity data with a heightened level of precision and accuracy. Furthermore, the improved GUI has been designed to incorporate real-time data visualization techniques. As the system continuously monitors and receives new activity data, the GUI dynamically updates visual representations, offering users an intuitive understanding of their progress towards meeting a performance indicator or ability to perform a single click update to the performance indicator. For example, upon determining a single action can be performed to improve a performance indicator, the GUI can be updated to include an actionable element that the user the user can select to improve the performance indicator. These technical refinements provide users with a richer, more insightful interaction experience while ensuring that the generated actions are tailored to individual user activities, preferences, and performance indicators.

Another technical improvement pertains to the system's predictive analytics in relation to memory management when dealing with a customer's performance indicator plans and the related timeframe. Leveraging algorithms, the system efficiently allocates memory resources based on the complexity and volume of data needed to assess the achievability of a performance indicator goal. The system dynamically adjusts memory distribution depending on the intricacy of reward structures and associated products. For example, if a user's objective of improving their credit score is linked to taking an action such as paying off a credit card, the memory allocated would be substantial, given the multidimensional data points evaluated. This provides improved performance while providing real-time feedback on the feasibility of the credit score goal, leading to optimal user experience and timely decision-making. In some embodiments, the system incorporates an advanced memory allocation algorithm specifically optimized for handling vast multidimensional datasets pertaining to activity data modeling and actionable step suggestions. Utilizing a combination of temporal locality (predicting the data access patterns based on recent accesses) and spatial locality (leveraging data that are adjacent to recently accessed data), the system prefetches relevant datasets into the cache memory, anticipating future operations. For example, when analyzing a user's trajectory towards a credit score improvement in relation to a real-time actionable suggestion, the system dynamically fetches, into the high-speed cache, data subsets like historical credit transactions, loan histories, related financial behaviors, and tasks or actions to perform the real-time actionable suggestion (e.g., API calls to communicate with other providers, login information, account information, etc.). This approach not only speeds up the decision-making process but also ensures efficient memory usage.

Referring to FIG. 1, a block diagram of an activity modeler architecture 100 including an analysis system 110 is shown, according to potential embodiments. The analysis system 110 can be associated with a provider, such as a service provider, bank, or financial institution (FI). The activity modeler architecture 100 further includes one or more user devices (e.g., user device 140), one or more data sources (e.g., data source 170), and an analysis system 110 (e.g., a computing system of a location of the FI). In some embodiments, the analysis system 110, user device 140 (as well as any additional user devices), and data source 170 are communicatively coupled. In some embodiments, the components of the activity modeler architecture 100 may be communicably and operatively coupled to each other over a network, such as network 130, that permits the direct or indirect exchange of data, values, instructions, messages, and the like (represented by the double-headed arrows in FIG. 1). The network 130 may include one or more of a cellular network, the Internet, Wi-Fi, Wi-Max, a proprietary provider network, a proprietary retail or service provider network, and/or any other kind of wireless or wired network.

Each system or device in activity modeler architecture 100 may include one or more processors, memories, and network interfaces (sometimes referred to herein as a “network circuit”). The memory may store programming logic that, when executed by the processor, controls the operation of the corresponding computing system or device. The memory may also store data in databases. For example, memory 120 may store programming logic that when executed by processor 116 within processing circuit 114, causes an update in the modeling dataset 122 from a user's account with information received from a user device 140 and/or data sources 170. The various components of devices in activity modeler architecture 100 may be implemented via hardware (e.g., circuitry), software (e.g., executable code), or any combination thereof. Devices and components in FIG. 1 can be added, deleted, integrated, separated, and/or rearranged in various embodiments of the disclosure.

The analysis system 110 may be operated by a provider. The analysis system 110 includes a network interface 112 and can be structured and used to establish connections with other computing systems and devices (e.g., the user devices 140, the data source 170, etc.) via the network 130. The network interface 112 includes program logic that facilitates connection of the analysis system 110 to the network 130. For example, the network interface 112 may include any combination of a wireless network transceiver (e.g., a cellular modem, a Bluetooth, transceiver, a Wi-Fi, transceiver, etc.) and/or a wired network transceiver (e.g., an Ethernet transceiver). In some arrangements, the network interface 112 includes the hardware (e.g., processor, memory, and so on) and machine-readable media sufficient to support communication over multiple channels of data communication. Further, in some arrangements, the network interface 112 includes cryptography capabilities to establish a secure or relatively secure communication session in which data communicated over the session is encrypted. In various embodiments, the activity modeler architecture 100 can adapt to network traffic needs by compressing content, by any computing device described herein, and sending it (e.g., via network 130) to various other computing devices, by adjusting security filters to remove junk traffic off network 130 (e.g., by monitoring packets), and so on. While described with regards to a provider, the analysis system 110 may be used in other scenarios. For example, the analysis system 110 may be used at a car dealership or car rental company, a hotel, a booking agent, and/or a medical office.

The processing circuit 114 includes a processor 116, a memory 120, a modeler circuit 124, a data control circuit 126, and a content control circuit 128. In other embodiments, the processing circuit 114 may contain more or less components than are shown in FIG. 1. The components of FIG. 1 are meant for illustrative purposes only and should not be regarded as limiting in any manner. The memory 120 may be one or more devices (e.g., RAM, ROM, Flash memory, hard disk storage) for storing data and/or computer code for completing and/or facilitating the various processes described herein. The memory 120 may be or include non-transient volatile memory, non-volatile memory, and non-transitory computer storage media. Memory 120 may include database components, object code components, script components, or any other type of information structure for supporting the various activities and information structures described herein. Memory 120 may be communicably coupled to the processor 116 and include computer code or instructions for executing one or more processes described herein. The processor 116 may be implemented as one or more application specific integrated circuits (ASICs), field programmable gate arrays (FPGAs), a group of processing components, or other suitable electronic processing components. As such, the analysis system 110 is configured to run a variety of application programs and store associated data in a database of the memory 120 (e.g., modeling dataset 122). One such application may be to provide data to the modeler circuit 124, data control circuit 126, and content control circuit 128.

Spatial and temporal locality principles provide the optimization of the processing circuit 114, particularly when it comes to efficient memory access. That is, spatial locality implies that the use of a specific memory location often correlates with the use of nearby memory locations. This is invaluable in the context of user data, where adjacent data points, such as consecutive credit transactions, are frequently accessed together. By efficiently grouping and prefetching this related data, the system enhances retrieval times and minimizes lag, ensuring real-time responses for user requests. Temporal locality, on the other hand, is predicated on the notion that previously accessed data is likely to be accessed again in the near future. By caching such frequently accessed data, the memory 120 can provide quicker access times for repetitive tasks, enhancing overall system efficiency. Leveraging both these concepts, the processing circuit 114 optimally manages its memory allocation, ensuring that relevant data, whether it's based on spatial proximity or recent access patterns, is promptly available for the processor 116 and other associated circuits.

As used herein, “activity data” refers to data of an account and/or identifier that is associated with economic or financial positions of the user. That is, activity data may create inferences about a person's borrowing practices. In some embodiments, activity data may involve qualitative data, quantitative data, or a combination of qualitative and quantitative data. Activity data could refer to bill payments, payment history, opening credit lines, amount owed, length of credit history, credit mix, new credit, closing credit lines, or debt repayment across at least one provider and includes at least one of performance indicator data, historical exchange settlements, and account exchange information. Furthermore, activity data may also encompass broader financial aspects such as revenue streams, expenditure patterns, asset management, liability assessments, investment portfolios, and overall fiscal strategies. Additionally, activity data may encompass real-time or near-real-time transactions, reflecting an up-to-the-minute snapshot of the user's financial status. Activity data may include, but is not limited to, employment history, income stability, education level, professional qualifications, assets (liquid and non-liquid), criminal record, character and fitness, professional reputation, fiscal responsibility, and so on. In some embodiments, the activity data may be specific to a certain activity. For example, driving records (e.g., vehicle accident reports) may be relevant activity data for a car loan and home activities (e.g., property damage) may be relevant activity data for a mortgage.

As used herein, a “performance indicator” refers to any measurement of user/entity performance, often financially or economically related (e.g., person's borrowing practices). That is, performance indicators can illustrate whether a person is a reliable borrower (e.g., a person that makes payments on time, has a stable debt-to-income ratio, possesses a history of responsible credit use, and/or maintains a diverse mix of credit types). In some embodiments, performance indicators may involve qualitative data, quantitative data, or a combination of qualitative and quantitative data. Performance indicators may include, but are not limited to, a variety of well-established creditworthiness metrics, such as credit scores (e.g., FICO score and VantageScore), user debt-to-income (DTI) ratio, credit utilization ratio (CUR), payment history, length of credit history, credit mix, public credit records (e.g., bankruptcies, tax liens, judgements, foreclosures, etc.), and so on. In some embodiments, a performance indicator may be determined based on a plurality of performance indicators. For example, determining a credit score may involve analyzing a person's credit mix, payment history, and length of credit history. In some embodiments, the performance indicators are produced by third-parties. For example, the credit score may be produced by credit bureaus (e.g., Equifax, Experian, and TransUnion). For example, a performance indicator could refer to a credit score, credit report, debt-to-income ratio (DTI), payment history, income stability, debt utilization ratio, savings and asset levels, among other performance standards. In another example, a performance indicator could refer to net profit margin, return on investment (ROI), cash flow forecasts, equity ratios, liquidity ratios, or customer retention rates, each reflecting various aspects of a user's financial health and operational efficiency. In particular, a performance indicator can be construed as a snapshot (e.g., real-time or near real-time) or representation of the financial health of a user or account at a given point in time. It's a multidimensional concept that encapsulates various economic indicators such as the user's solvency (its ability to meet long-term obligations), assets (what it owns), liabilities (what it owes), and other related financial markers. Often, the analysis system 110 can set rules for determining a performance indicator based on activity data. For example, one type of performance indicator, the credit score is based on the activity data of amounts owed, new credit, length of credit history, payment history, credit mix, and so on.

As used herein, a “performance product” refers to a financial or economic instrument. For example, a performance product can be loans (e.g., personal loans, car loans, mortgage loans), credit cards with varying interest rates and credit limits, savings accounts with differential interest rates, investment portfolios tailored to specific risk profiles, insurance policies (e.g., life, property, auto), retirement planning products, and so on. These performance products can be customized to suit an individual's financial health, based on their creditworthiness, assets, liabilities, and overall fiscal strategies. Furthermore, performance products may offer flexible terms or special offers based on one or more performance indicators of the user. As used herein, a “performance parameter” refers to provisions or terms of a financial or economic instrument that dictate its functionality, benefits, restrictions, and obligations. The performance parameters can be seen as the fine print or detailed specifications of the performance product. For example, for a loan, performance parameters could encompass interest rate, repayment period, monthly installment amount, fees, penalties for early or late payment, and other conditions or covenants. For a credit card, performance parameters may include credit limit, cashback or reward points rate, annual fees, and APR (Annual Percentage Rate). In the context of an insurance policy, it might relate to coverage limits, deductibles, premium amounts, and specific conditions or events under which a claim can be made. Performance parameters serve to define the scope, advantages, and responsibilities associated with a given performance product, allowing entities to make informed decisions about which product suits their needs best.

As used herein, a “performance parameter” refers to the provisions, terms, and minimum requirements associated with a financial or economic instrument that dictate its functionality, benefits, restrictions, and obligations. These parameters outline both the specifications of the performance product and the eligibility criteria an entity or user must meet to obtain the performance product. For example, for a loan, performance parameters could encompass interest rate, repayment period, monthly installment amount, fees, penalties for early or late payment, as well as eligibility requirements like minimum credit score, acceptable debt-to-income ratio, stable employment history, and minimum monthly or annual income. For a credit card, performance parameters may include credit limit, cashback or reward points rate, annual fees, APR (Annual Percentage Rate), and qualification metrics such as past payment history, current debt levels, and absence of recent bankruptcies. In the context of an insurance policy, performance parameters might relate to coverage limits, deductibles, premium amounts, specific conditions or events under which a claim can be made, and prerequisites like a clean driving record for auto insurance or a health assessment for life insurance.

As used herein, “actionable activity” or “actions” refers to any activity that can be taken by a user in response to activity data. In various embodiments, the actionable activity or action can be performed via a single step (e.g., selection a button, one click, a slide). For example, an actionable activity can refer to making a payment, automating future payments, remediating past payments, remediating past missed payments, consolidating lines of credit, generating a reward, performing a fraud check on exchanges, generating a notification, registering a new account or line of credit, paying a minimum, or other user activities. In another example, an actionable activity can refer to initiating a financial danger assessment, tailoring personalized financial products, or restructuring existing financial arrangements in alignment with the user's current financial standing. As such, the actionable activity can be one or more activities the user or computing systems can execute or perform to reach or progress to reaching a goal, such as qualify for a performance product. In general, some or more actionable activities can be configured to attempt to improve (e.g., if executed or performed) one or more performance indicators of the user (e.g., to qualify for a performance product). It may also encompass engaging in proactive communication with the user to provide financial counseling, recommend investment strategies, or offer assistance in budget planning. It should be understood that the actionable activities can be automatically performed (e.g., in real-time, after user approval such as a single click, after predefined time) by the modeler circuit 124 which can be configured to interpret and respond to various triggers and conditions within the activity data. Through a systematic integration with relevant financial systems (e.g., API integration), the modeler circuit 124 can automatically execute a range of activities such as payment processing, credit line management, detections, and customer communication, all aligned with the predefined criteria and the financial context of the user. The automated capabilities of the modeler circuit 124 can increase efficiency and responsiveness, and ensure a consistent and informed approach in handling the multifaceted financial or economic needs of the user.

As used herein, “resource allocation authorizations” refer to permissions or rights granted by one or more provider computing systems to access and utilize specific resources, guided by certain authorization parameters. These authorization parameters may define the extent and manner in which various financial systems, databases, or computational capabilities can be accessed and applied. The resource allocation authorizations may be analyzed, bundled, and modeled to generate new authorization parameters, potentially considering common or conflicting aspects across different authorizations. Accordingly, this process enables the creation of a bundled resource authorization that aligns with predefined rules or user-defined preferences, ultimately aiming to provide a positive impact on performance indicators related to the financial or economic health of a user. Additionally, the resource allocation authorizations provide a role in managing obligations, such as debt repayment, through the estimation of elimination periods and other financial strategies.

The processing circuit 114, interacting (e.g., communicating with by sending requests and/or commands/signals) with the memory 120 can store a variety of data in the modeling dataset 122, according to some embodiments, including user data structures. The modeler circuit 124 can use data stored in the modeling dataset 122 and other gathered data to generate a performance indicator which could then be stored in the modeling dataset 122. The modeling dataset 122 may also be configured to store a user data structure which can include updated personal information for customer accounts associated with the provider (e.g., the FI). For example, the modeling dataset 122 can store personal user information that models account activity affecting performance indicators, such as previous exchanges for loans, bills, credit card payments, payments to other accounts either owned or not owned by the user, among other exchanges. The modeling dataset 122 can store other personal user information used in modeling activity such as name, age, gender, address, education, occupation, etc., customer preferences, such as notification preferences, security preferences, etc., and authentication information, such as customer passwords, biometric data for the customer, geometric information (e.g., latitude, longitude), etc. In some embodiments, the modeling dataset 122 can include a token vault that stores an associated customer token and/or device token for each customer account. The modeling dataset 122 may further be configured to store financial data for each customer account, such as past transactions, different provider account information (e.g., balances, debt, type of account, etc.), investments, loans, mortgages, and so on.

In some embodiments, the memory 120 and modeling dataset 122 may be communicably coupled to the modeler circuit 124, data control circuit 126, or content control circuit 128. It should be understood that “circuit” used herein can be any processing circuit(s) or computational systems designed to perform specific tasks, including but not limited to microprocessors, microcontrollers, application-specific integrated circuits (ASICs), field-programmable gate arrays (FPGAs), or any combination thereof, capable of executing the required functions and operations for handling, analyzing, and processing the activity data, performance indicators, and actionable activities as described herein. The modeler circuit 124 can implement modeling operations of the analysis system 110. In various arrangements, the modeler circuit 124 can be configured to receive a plurality of data from a plurality of data sources (e.g., memory 120, modeling dataset 122, data control circuit 126, content control circuit 128, user device 140, data source 170) via one or more data channels (e.g., over network 130). Each data channel may include a network connection (e.g., wired, wireless, cloud) between the devices or systems and the analysis system 110. For example, the modeler circuit 124 could query the memory 120 for data of the modeling dataset 122 and use the modeling data to generate one or more performance indicators (e.g., the modeling dataset that includes activity data such as past bills can be used by the modeler circuit 124 to create a performance indicator that resembles an up-to-date credit score or economic indicator).

The modeler circuit 124 can be further configured to receive new activity data or an updated performance indicator from the input/output device 132 of the analysis system 110 or from the modeling dataset 122. For example, the modeler circuit 124 may be configured to continuously monitor and receive new information from a user device 140, data source 170, or provider system 135 via the network 130 and determine the effect on the one or more performance indicators. New data can affect the modeling dataset 122 and thereon after the modeler circuit 124, data control circuit 126, content control circuit 128, and other parts of the analysis system 110. For example, a user could pay off a previous debt after their activity data has already been sent to the analysis system 110. A source (e.g., user device 140, data source 170, or provider system 135) may then send the activity data, (e.g., debt payment) to the analysis system 110. Because debt payment can be a significant factor affecting the performance indicator, not only would the modeling dataset 122 be updated, but the modeler circuit 124 would update the performance indicator. For example, the debt payment could cause the modeler circuit 124 to change the credit capabilities of the user, which affects what products and actionable activities (e.g., to increase the performance indicator) are available to the user.

For example, the modeler circuit 124 can be configured to model user activity data utilizing one or more weights to generate one or more performance indicators. In some embodiments, the performance indicator created by the modeler circuit 124 corresponds to an economic position or financial position of the user/customer. The modeler circuit 124 can continuously update the performance indicator based on continuously updating the user activity data received by the analysis system 110 from various sources (e.g., user device 140, data sources 170, or provider systems 135). Because many of the performance indicators can be proportional to changes in activity data, the modeler circuit 124 can continuously update the performance indicator in response to updated user activity data. For example, if a user were to open a new line of credit, the modeler circuit 124 could determine the effect of the new line of credit has on the performance indicator to determine what actions could be offered to increase the performance indicator. For example, the modeler circuit 124 could update the performance indicator and determine that a new line of credit could allow the customer to consolidate other lines of credit into the new one that could increase their performance indicator, consolidate bill payments into the new credit line that would also could increase their performance indicator, or simply update the performance indicator to note a new line of credit and its effects on other performance indicators, among other capabilities.

In some embodiments, the modeler circuit 124 can determine that new data in the modeling dataset 122 contains a discrepancy or violation. For example, the modeling dataset 122 could receive new activity data or performance indicators including an updated economic or credit report on the user. When the modeler circuit 124 uses the updated activity data to create an updated performance indicator, the modeler circuit 124 could flag a discrepancy in the updated activity. For example, the credit report could include a false line of credit that the previous activity data did not include. The modeler circuit 124 could then model the user activity data to create a performance indicator that also denotes a false line of credit to be addressed by the data control circuit 126 or content control circuit 128.

In some embodiments, the modeler circuit 124 can model activity data utilizing one or more weights applied to a plurality of dimensions to generate a performance indicator of the user. The modeled activity data can also be used to determine information such as how performance indicators are affected based off the data in the memory 120 and rules on how activity data and performance indicators affect actions the user could take to increase their performance indicator, future activities, and future performance indicators, among other. The modeler circuit 124 can be configured to perform data fusion operations, including operations to generate and/or aggregate various data structures stored in memory 120. For example, the modeler circuit 124 can be configured to aggregate data stored in memory 120, such as aggregating the total amount of lines of credit open by a user for purposes of determining if a new line of credit could be opened to improve a performance indicator or if the user's performance indicator would benefit from consolidating lines of credit. The data may be a user data structure associated with a specific user and include various data from a plurality of data channels.

In some embodiments, the modeler circuit 124 can identify or apply one or more weights to a plurality of dimensions of the activity data. In some embodiments, the modeler circuit 124 can provide information to the data control circuit 126 and content control circuit 128. For example, if a user were to repeatedly pay a number of bills on time for an extended period of time, the modeler circuit 124 may determine an increase in a user's performance indicator and then subsequently additional actions to update the performance indicator. The modeler circuit 124 can determine through its modeling that the bill payments warrant an increase in one or more performance indicators and indicate to the data control circuit 126 or content control circuit 128 to update the GUI to present the update and one or more actions to the user.

In some embodiments, each dimension of the plurality of dimensions corresponding to a distinct weight of the one or more weights in generating the performance indicator (i.e., credit score). The dimensions can include, but are not limited to, data elements of user's activity patterns, diversity of activity types, duration of one or more activities, recent changes in activity habits, and consistency in maintaining the one or more activities. For example, the diversity of activity types dimension might consider the range of financial behaviors a user engages in, such as maintaining a checking account, applying for loans, or using credit cards. In another example, the data elements of user's activity patterns dimension could be the frequency with which a user makes large purchases on their credit card. If a user tends to make big purchases every month but pays them off promptly, this pattern might reflect a higher level of financial responsibility. In yet another example, one or more activities dimension might be the length of time a user has had a particular loan or credit card. If a user has maintained a credit card (or other financial products, such as on-time payment of loans, etc.) for several years without any negative incidents, this could indicate a longer history of creditworthiness. In yet another example, recent changes in activity habits dimension could indicate if a user who typically pays off their credit card (or other financial products) in full every month suddenly starts carrying a balance or makes multiple late payments in a short period. Such recent changes could indicate potential financial distress or a shift in financial habits. In yet another example, the consistency in maintaining the one or more activities dimension could be how regularly a user pays their monthly bills. If they consistently pay their bills on time every month, this could indicate a strong level of financial reliability and responsibility. Accordingly, the modeler circuit 124 can categorize activity data into a dimension by analyzing patterns, behaviors, or characteristics within the collected activity data and grouping similar items under a specific category or label (i.e., dimension). For example, all data related to payment timelines—like on-time payments, early payments, and late payments—might be grouped into a payment consistency dimension.

Weights can represent the significance or influence of each dimension on the final performance indicator. Different dimensions can be given different weights based on their perceived importance in determining the credit score. For example, consistency in maintaining the one or more activities might be given a higher weight because regularly paying off debts without delay is viewed as a strong indicator of creditworthiness. Conversely, recent changes in activity habits might have a lower weight if the system values long-term consistency over short-term fluctuations. In some embodiments, applying one or more weights to a plurality of dimensions of the activity data can include multiplying the value of each dimension by its respective weight and summing the results to obtain the performance indicator. This weighted sum ensures that the performance indicator accurately reflects the current, real-time, user's financial behaviors and trustworthiness in repaying debts. For example, if a user has a high diversity of activity types but recent negative changes in activity habits, the performance indicator might remain neutral or decrease slightly depending on the assigned weights of these dimensions. It should also be understood that weights can be tailored differently (i.e., each weight can be user specific) for each individual based on their unique financial history and behavior. For some people, recent financial behaviors might be more relevant, leading to a higher weight for recent activity, while for others with a long-standing credit history, the higher weighted dimensions may lean more towards long-term consistency. Thus, these variations in weights ensure that the performance indicator provides a more personalized and accurate representation of an individual's performance indicator, in real-time (or near real-time) when activity data is modeled.

In some embodiments, the modeler circuit 124 can determine, based on the data in memory 120, that a user's activity data, if altered in a future scenario, could provide an additional benefit to one or more of the performance indicators. In some embodiments, the modeler circuit 124 can identify a plurality of resource allocation authorizations associated with at least two provider computing systems (e.g., provider systems 135, data sources 170). In some embodiments, the plurality of resource allocation authorizations may correspond to at least one authorization parameter to utilize one or more resources of each of the provider systems (e.g., provider systems 135, data sources 170). In some embodiments, the modeler circuit 124 could further determine a bundled resource authorization to offer the user to be presented to the user by the data control circuit 126 or content control circuit 128. In some embodiments, the bundled resource authorization includes the modeler circuit 124 generating one or more new authorization parameters based on the authorization parameters of each of the provider systems 135. For example, the modeler circuit 124 could determine, based on data in the memory 120 that a user has lines of credit open with multiple providers or bills being paid at multiple providers. If the lines or credits or bill payments satisfy predetermined rules for configuring future activity such as offering a bundled line of credit, then the modeler circuit 124 may configure a bundling scenario and indicate to the data control circuit 126 or content control circuit 128 to update the GUI to present the scenario to the user with a one-click or one action option to perform bundling and improving their performance indicator.

In some embodiments, the modeler circuit 124 can determine one or more common parameters across the plurality of resource allocation authorizations and can determine one or more conflicting parameters across the plurality of resource allocation authorizations. In some embodiments, the modeler circuit 124 can model the one or more common parameters and the one or more conflicting parameters to generate the one or more new authorization parameters. In some embodiments, modeling includes combining one or more common parameters and resolving the one or more conflicting parameters based on a set of predefined rules or user-defined preferences. For example, if a user has lines of credit open at multiple institutions, the processing circuit 114 could offer an action on the GUI To combine the lines of credit together into one line. Further, the processing circuit could identify if the different institutions have conflicting parameters such as associated a different credit score with the user and resolving the discrepancy. In some embodiments, consolidating the plurality of resource allocation authorizations into the bundled resource authorization is done to provide a positive impact on the one or more performance indicators. For example, the processing circuit 114 and modeler circuit 124 may only provide a consolidation of bundled lines of credit if consolidation positively affects a user's credit score. In some embodiments, the bundled resource authorization includes an estimated elimination period for satisfying one or more obligations associated with the plurality of resource allocation authorizations. For example, the processing circuit 114 may provide for an education aspect such as providing an estimated payoff time to pay off debt from one or more of the user's credit lines.

In some embodiments, the functionalities of the modeler circuit 124 include the principles of spatial and temporal locality in relation to data access from memory 120. Specifically, when the modeler circuit 124 processes large volumes of user activity data and performance indicators, the sequence and proximity of data accesses can be efficiently organized and predicted. For example, by understanding spatial locality, when a certain activity data of a user is accessed, adjacent or related data in memory 120, such as consecutive credit transactions or related credit lines from the same institution, can be pre-fetched, anticipating further related operations. This enhances the speed and efficiency of modeling, particularly when constructing or updating the user data structure. Conversely, utilizing the principle of temporal locality, frequently accessed patterns of user behavior, like repetitive credit inquiries or regular monthly transactions, can be cached for rapid access. Given the dynamic nature of user credit data, and the need for timely updates to ensure accuracy, the modeler circuit 124 benefits greatly from these principles. When predicting or simulating future credit scenarios, or predicting what actions can immediately improve a performance indicator, or consolidating data from various sources, an effective utilization of memory access patterns directly translates to quicker modeling outputs, more accurate predictions, and a streamlined user experience.

For example, common parameters might be identified when two provider computing systems adhere to the same regulatory compliance standards, thus allowing for a unified approach to data security and access control. In this example, the modeler circuit 124 can combine these common parameters into a single set of authorization rules. Conversely, conflicting parameters may arise when different provider systems have divergent interest rates or lending criteria for lines of credit. One provider system might offer preferential rates to long-standing customers, while another provider system may base its rates on recent credit history. In such a case, the modeler circuit 124 would identify and resolve these conflicts, potentially by adopting an average interest rate or by applying predefined rules that prioritize one provider's criteria over the other. In another example involving three providers, there might exist both common and conflicting parameters within the resource allocation authorizations. For example, all three providers might adhere to a common parameter such as a standardized data encryption protocol for securing financial transactions. This commonality ensures that data integrity and security measures are uniform across all systems. However, conflicting parameters may emerge in areas such as lending policies or customer rewards programs. Provider A might offer a line of credit with a reduced interest rate for new customers, Provider B may prioritize a rewards program based on customer loyalty, while Provider C might have a hybrid approach combining both elements. In this example, the conflicting parameters represent divergent strategies for customer engagement and retention. The modeler circuit 124 would identify these conflicts and might resolve them by determine an action to bundle the resource authorization that attempts to balance or harmonize these different approaches and improve or increase the performance indicator of the user. The resolution could involve a weighted scoring system that takes into account the unique offerings of each provider, creating a tailored financial product that reflects the user's particular needs and preferences.

In some embodiments, the data control circuit 126 can be configured to identify user activity data and one or more previous or historical performance indicators of a user. The data control circuit 126 can parse through various financial transactions and behaviors to extract relevant activity data. This data can range from concrete financial actions such as bill payments, credit line histories, to broader aspects like professional reputation. In some embodiments, depending on its relevance to particular financial scenarios, the data control circuit 126 categorizes and prioritizes the extracted data. In some embodiments, the data control circuit 126 can categorize the activity data into dimensions. For example, while driving records may be relevant for assessing car loans (e.g., a first dimension may be weighted less), home-related activities are prioritized for mortgages (e.g., a second dimension may be weighted more). Additionally, the data control circuit 126 identifies historical performance indicators which are quantitative or qualitative metrics indicating a user's financial health. These indicators include metrics, including but not limited to FICO scores, debt-to-income ratios, and others. Each indicator, while standalone, may derive its value from various underlying data points. Furthermore, the data control circuit 126 integrates inputs from third-party entities, such as credit bureaus, consolidating external and internal data for an assessment of a user's financial health.

In some embodiments, the modeler circuit 124 can be configured to model the user activity data to generate one or more performance indicators and determine one or actions including a plurality of performance parameters corresponding to a future or updated performance indicator of the user. An action can correspond to various loans (e.g., personal, vehicle, or property loans) to credit cards and savings accounts. The action could also extend to tailored investment portfolios reflecting a user's risk appetite or coverage policies spanning life, property, and automobile coverage, as well as retirement planning tools. The objective of the action is to align it with an individual's financial profile, which encompasses their assets, creditworthiness, existing liabilities, and overarching financial plans to improve or increase their performance indicator. To ensure that these actions are fine-tuned to the improve the performance indicator, the modeler circuit 124 incorporates weighting and dimensions.

In some embodiments, the content control circuit 128 can be configured to generate and present a graphical user interface (GUI) including one or more actionable elements associated with at least one action to update the performance indicator. For example, the GUI can include a series of actionable elements (e.g., specific one-click actions or activities that users can undertake to immediately or near-immediately improve or increase their performance indicator). For example, when the user's activity data suggests they have pending bills, the actionable element may prompt them to make a payment. In situations where the activity data indicates missed payments from the past, the GUI could provide options for users to rectify those missteps and immediately improve their real-time, current performance indicator, either by remediating past payments or by consolidating various credit lines to streamline their financial commitments (e.g., via one action on the GUI). Users might also be given alerts or notifications about certain actions to immediately improve their performance indicator, “nudging” them to take corrective or beneficial actions. Additionally, the GUI can facilitate new financial endeavors. For example, if a user wants to expand their credit horizon which could improve their performance indicators, options to register a new account or credit line might be presented. In some embodiments, the modeler circuit 124, in conjunction with the content control circuit 128, can automate several of these actions. Based on the activity data and specific performance indicator, certain actions can be executed in real-time, post the user's selection of the actionable element, or after a certain predefined interval.

In some embodiments, the data control circuit 126 can be configured to monitor the user activity data and the one or more performance indicators of the user based on receiving new activity data corresponding to the future performance indicator from a user data source. In general, the data control circuit 126 can track the user's ongoing activity data, a repository of the user's financial behaviors and actions. Concurrently, it can also monitor the performance indicators linked to the user. Upon receiving new activity data, which likely projects potential future actions or behaviors of the user, the data control circuit 126 could employ data parsing algorithms to segregate incoming data, ensuring that the information pertinent to future performance indicators is extracted accurately. Post-extraction, normalization methods would be applied to standardize this data. Furthermore, the data control circuit 126 could also implement data comparison algorithms. These algorithms can compare the new activity data against existing benchmarks, thresholds, or patterns previously recorded. If anomalies or significant deviations are detected, the data control circuit 126 can flag them for further analysis or action. In some embodiments, machine learning models could also be integrated, enabling the data control circuit 126 to learn from the continuous stream of data. Over time, the data control circuit 126 can refine the accuracy and relevance of monitoring.

In various arrangements, the modeler circuit 124 can be configured to receive user activity data and one or more historical performance indicators of the user from a plurality of data sources (e.g., memory 120, modeling dataset 122, data control circuit 126, content control circuit 128, user device 140, data source 170) via one or more data channels (e.g., over network 130). Each data channel may include a network connection (e.g., wired, wireless, cloud) between the devices or systems and the analysis system 110. The modeler circuit 124 then uses this data to generate one or more real-time, current performance indicators including a potential action to improve their performance indicator.

The modeler circuit 124 can be further configured to receive new activity data or an updated performance indicator from the input/output device 132 of the analysis system 110 or from the modeling dataset 122. For example, a user could make a significant financial transaction after their initial data was received. Such new data can be conveyed to the analysis system 110. Recognizing this, the modeler circuit 124 may model the updated user activity data to potentially generate new or adjusted actions based on an updated performance indicator. For example, a recent debt payment could influence the action to improve their performance indicator, altering the actions related to improving their performance indicator. As the modeler circuit 124 receives and processes user activity data, it can model this data to generate performance indicators and determine actions customized to the user.

In general, the modeler circuit 124 utilizes the user activity data to generate performance indicators to tailor actions for the user to improve or increase their performance indicator. These actions, reflecting options to increase performance indicators, can be user specific. They can shift in response to a user's evolving financial behaviors as evident from their user activity data. In some embodiments, the modeler circuit 124 can provide users with a clear roadmap when aiming for a specific performance indicator (e.g., like obtain a minimum performance indicator to obtain a mortgage loan). This roadmap might highlight actions that would immediately or near-immediately increase their eligibility for the desired product. In some embodiments, the modeler circuit 124 can incentivize these behaviors, offering prospective mortgage rates based on the predicted positive performance indicator of the user upon performing the at least one action. If the user's future rate appears promising, the provider may lock in a competitive rate ahead of time. In some embodiments, the modeler circuit 124 can offer rewards with the action. These could range from points that could be used towards a mortgage to reward points for credit cards. From an educational perspective, users could be offered reward baskets that level them up in financial literacy, or tangible benefits like a free safety deposit box, bundled offers, or discounted rates on other services if certain one-click action is performed. In some embodiments, the modeler circuit 124 can present the user with a clear offer: if they agree to certain conditions (e.g., performance parameters), they can accept (i.e., the action of selecting the actionable element) and embark on the journey towards achieving the offer (e.g., the performance product).

In some embodiments, the processing circuit 114 can monitor the one or more performance indicators (and user activity data) based on continuously receiving new information from a user device of the user (e.g., user device 140), one or more data sources (e.g., data source 170), and one or more provider systems (e.g., provider system 135). For example, the processor can determine a user plan (e.g., a one-click action, and additional action over time) based on the user activity data, such as a plan aimed to increase a credit score (e.g., immediately and over time). The processing circuit 114 will then continuously monitor user activity relating to the plan, and the modeler circuit 124 can continuously monitor user activity to update the user data structure (sometimes referred to herein as the “user activity data”, where the “user activity data” that is old, new, or in the future is stored and updated). In some embodiments, the processing circuit 114 can determine a discrepancy in the user activity data or performance indicators based on previous activity of the user. For example, a credit report could include a line of credit that the customer did not have. In some embodiments, the processing circuit 114 can determine a violation associated with the actionable activity based on a comparison between user activity data or a performance indicator and a desired action for increasing the performance indicator. In some embodiments, the comparison identifies an activity that is counter to the desired action. For example, the user may pay a bill late after having a plan to increase their credit score. In some embodiments, the processing circuit 114, through the data control circuit 126 or content control circuit 128, can remediate the discrepancy or violation by at least one of two methods: presenting an alert on the GUI including remediation instructions for the user, or establishing, via an alert on the GUI, a communication session with an external system associated with the counteractivity to the desired action. In some embodiments, the processing circuit can additionally update the external system to remove or update the counteractivity to the desired action or initiating an exchange between an account of the user and the external system. For example, in response to the bill being paid late, the system could contact the company that allowed the payment to be made late, contact a credit card company to close a new account, or initiate a payment transaction to address a late payment, among other responses. In another example, if the processing circuit 114 detects a late payment that contradicts the entity's or user's plan to improve their credit score, the processing circuit 114 may automatically initiate the payment transaction to the external system associated with the bill. This corrective action (e.g., done after obtaining the user's consent, done automatically without user's consent), not only addresses the late payment but also sends a request to update the credit reporting information, mitigating the potential negative impact on the entity's or user's performance indicator(s).

In some embodiments, the processing circuit 114 and modeler circuit 124 can determine one or more characteristics of the user activity data causing the update to the one or more performance indicators and generate an action and/or a plan (with actions) associated with at least one different characteristic to cause an increase to the one or more performance indicators. In some embodiments, in response to the user performing at least one different characteristic, the processing circuit 114, through the content control circuit 128, can provide and present a reward in the GUI. In some embodiments, the reward enables another feature of the GUI. For example, the processing circuit 114 can identify financial behavior of a user such as their habits for budgeting, saving, investing, spending habits, debt management, financial goal setting, financial planning, tracking expenses, risk management, or financial education, among other habits. For example, the processor can determine when the user is more likely to miss a bill payment and can further generate a plan such as adding funds to a bill payment pool in order to pay all bills on time and further increase credit. After implementing the plan and the user no longer misses bill payments, the processor 116 and content control circuit 128 can provide a reward to the user through the I/O device 132. For example, if the user follows a one-click action or plan to no longer miss any payments, the reward may be access to additional financial products of the bank. Financial products of a bank could include updated or more favorable accounts, certificates of deposits, loans, credit cards, debit cards, investment services, insurance products, foreign exchange services, and online or mobile banking services, among other products.

In some cases, the modeler circuit 124 may analyze the user's historical payment data, spending habits, and current financial situation to predict that the user or entity is likely to miss an upcoming bill payment, and this prediction could be based on a trend showing consistent late payments or depletion of funds in the associated account before the payment due date. This analysis may lead to the generation of a targeted alert or recommendation, encouraging the user or entity to take corrective action (i.e., a one-click action) such as rescheduling payments or reallocating funds. In response to predicting a likely missed payment, the modeler circuit 124 could also present an offer (e.g., and sometimes automatically accept the offer without user or entity interaction) for a one-time financial product specifically tailored to help the user or entity avoid missing the payment, such as a short-term loan with favorable terms or a temporary increase in the overdraft limit. This offer could be made through the GUI, providing the user or entity with detailed information about the product, its benefits, and an option to accept the offer immediately, thereby giving the user or entity an opportunity to make the bill payment on time without negatively affecting their performance indicator or incurring late fees.

In some embodiments, the processing circuit 114 can perform an analysis check on previous activities of the user. For example, in some embodiments, the modeler circuit 124, data control circuit 126, or content control circuit 128 could run a security verification on any previous activity received from a user device 140, data source 170, or provider system 135 via the network 130. In some embodiments, the security verification can create a security profile corresponding to any previous activity, based on factors such as origin, transaction type, transaction location, transaction amount, and more. In some embodiments, actions that depend on the security profile of previous activities are triggered by a security threshold. According to some embodiments, previous activities are inconsistent with previous user activity data can trigger actionable events. For example, in some embodiments, when a security profile is below a security threshold, the data control circuit 126 could send instructions to the content control circuit 128 that includes sending a GUI to the user device 140 with an actionable element and at least one message associated with the triggering data. In particular, if a large and unexpected transaction from a foreign location is detected, and it falls below (or above, depending on how the threshold is set) the established security threshold, the data control circuit 126 might prompt the content control circuit 128 to send a notification to the user's mobile device through the GUI, asking them to confirm or deny the transaction.

In some embodiments, the processing circuit 114 can determine that at least one previous activity is a fraudulent activity within the user activity data and automatically remove the fraudulent activity from the user activity data. In some embodiments, the modeler circuit 124 can additionally remodel the activity data and the one or more performance indicators to generate an updated user data structure. For example, the processing circuit 114 can determine if one of a user's previous transactions was a transaction from the user's stolen credit card. Removing this stolen transaction from the user's data set and remodeling the user data structure can provide for a more accurate depiction of a user's spending habits or other performance indicators.

In some embodiments, at least one future activity of the user can be associated with a statement settlement action. In some embodiments, the processing circuit 114 or more specifically the modeler circuit 124 can determine the statement settlement action will cause a negative account balance associated with an account of the user. In some embodiments, the processing circuit 114 can update an automatic exchange associated with the statement settlement to cause the non-negative account balance associated with the account of the user and configure a different statement settlement action to satisfy the difference between the non-negative account balance and the negative account balance. For example, through the modeling, the system can determine if the user has, or is likely to have a future bill payment. If the system determines the bill will result in a negative account balance (e.g., overdraft), the system can automatically setup another action (e.g., after a one-click action presented on the GUI), such as payment with a different account or payment with a credit card, among other actions, to remediate the negative balance. In some embodiments, the future activity can include a future exchange event associated with the user, and the future exchange event can cause a change in the activity data, and in response to a selection of at least one actionable element, the future exchange is automated based on configuring an automatic exchange between a user's account and an external system. For example, the future exchange event could be a bill pay, which could affect the user data structure such as the account balance for the user. If the actionable element of the GUI is to set up a future automatic payment for one or more bills, if the user accepts, then the system can automatically pay the future bills, even if the future bills are occurring through an external system, such as at another FI.

In some embodiments, the data control circuit 126 can be configured to perform data fusion operations, including operations to generate various data structures stored in memory 120 and used by the various circuits described herein. For example, the data manager can communicate with the user device or data sources by collecting, receiving, or identifying data relevant for use by the other circuits. The data control circuit 126 can also be configured to receive a plurality of entity data. In some arrangements, the data control circuit 126 can be configured to receive data regarding the network 130 as a whole instead of data specific to a particular entity. The received data that the data control circuit 126 receives can be data that analysis system 110 aggregates and/or data that the analysis system 110 receives from the data sources 170 and/or any other system described herein (e.g., provider system 135, user device 140).

The content control circuit 128 can include circuitry for storing information such as rules for offering actionable activities (i.e., actions) and elements for customized user activity. The content control circuit 128 can receive data for determining or displaying actionable activities to the user from any component of the activity modeler architecture 100 (e.g., receives a one-click action from the modeler circuit 124 affecting a performance indicator). The content control circuit 128 may additionally store this information in memory 120. In some embodiments, the content control circuit 128 can generate content for displaying to users. The content can be selected from various resources (e.g., an update for a performance indicator sent from the data control circuit 126). The content control circuit 128 can also be structured to provide content (e.g., via a graphical user interface (GUI)) to the user device 140 over the network 130, for display within the resources. For example, the content control circuit 128 can present a GUI including actionable elements and a message associated with the actionable activity that may affect the performance indicator (e.g., one-click affecting the performance indicator in real-time or substantially instantly). The GUI can be sent via the I/O device 132 to the user device 140 through the network 130.

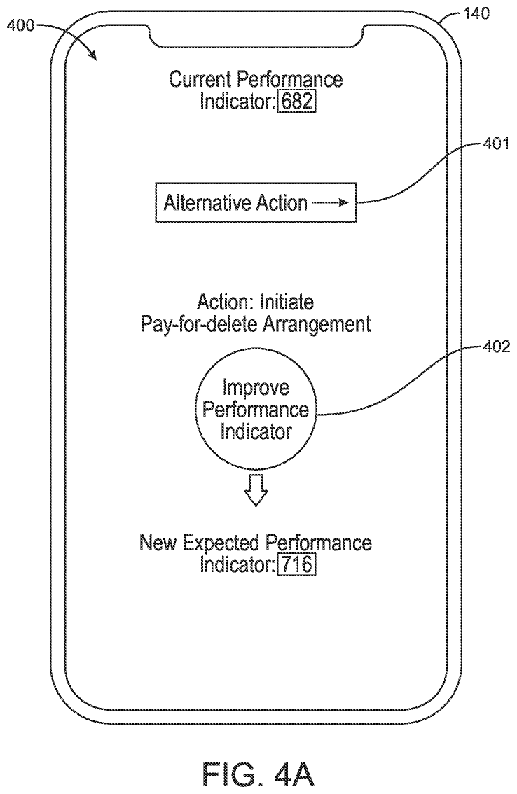

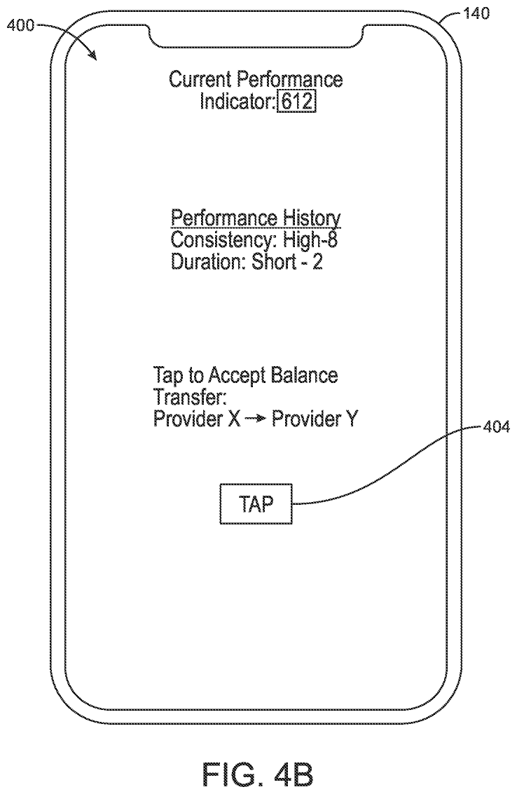

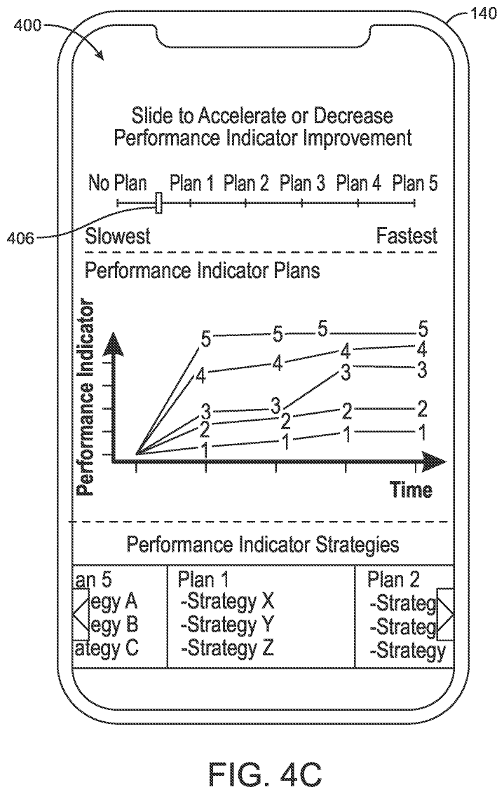

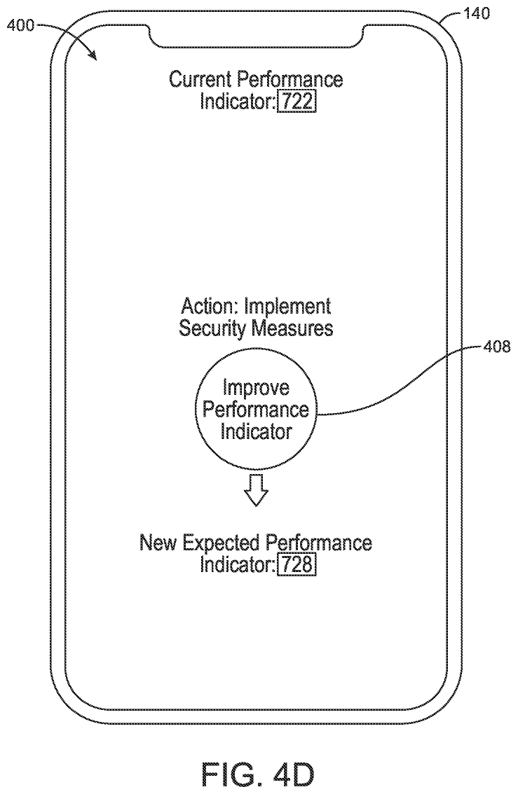

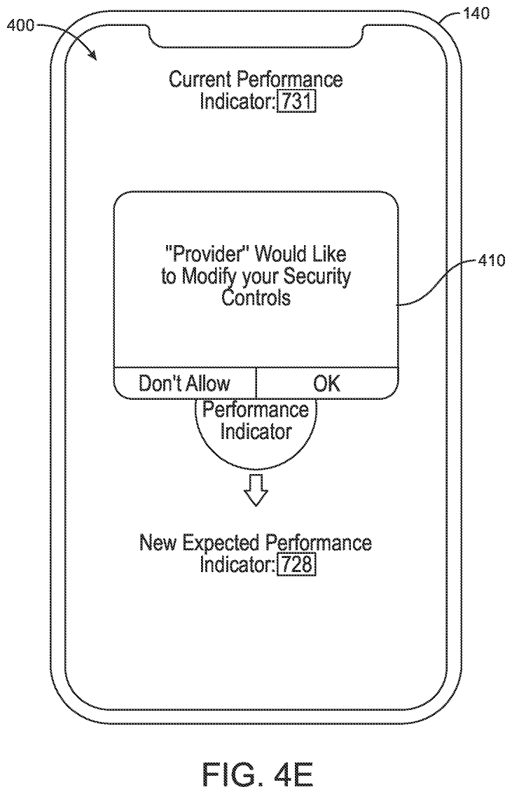

The content control circuit 128 can generate interfaces such as a plurality of customized dashboards, such as those described in detail below, with reference to FIGS. 4A-4E. The content control circuit 128 can generate customized user-interactive dashboards for one or more users, such as the user device 140, based on data received from the user device 140, data source 170, and/or any other computing device described therein. The generated dashboards can include various data (e.g., data stored in the content control circuit 128 and/or modeling dataset 122) associated with one or more users such as actionable events, performance products, performance parameters, actionable events, activity data, performance indicators, past, current, or future exchange history, account information, multidimensional scores, actionable activities/executables, and/or others. In certain embodiments, the analysis system 110 includes an application programming interface (API) and/or a software development kit (SDK) that facilitate the integration of other applications with the analysis system 110. For example, the analysis system 110 is configured to utilize the functionality of the user device 140 interacting with the user client application 154 through an API.

Still referring to FIG. 1, the input/output device 132 (depicted as “I/O Device 132 in FIG. 1) is structured to receive communications from and provide communications to users associated with the analysis system 110. The input/output device 132 is structured to exchange data, communications, instructions, etc., with an input/output component of the analysis system 110. In one embodiment, the input/output device 132 includes communication circuitry for facilitating the exchange of data, values, messages, and the like between the input/output device 132 and the components of the analysis system 110. In yet another embodiment, the input/output device 132 includes machine-readable media for facilitating the exchange of information between the input/output device and the components of the analysis system 110. In yet another embodiment, the input/output device 132 includes any combination of hardware components, communication circuitry, and machine-readable media.

In some embodiments, the input/output device 132 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output device 132 may provide an interface for the user to interact with various applications stored on the analysis system 110. For example, the input/output device 132 may include a keyboard, a keypad, a mouse, joystick, a touch screen, a microphone, a biometric device, a virtual reality headset, smart glasses, smart headsets, smart watches, smart IoT devices (attached to or analyzing various aspects of a body) and the like. As another example, input/output device 132, may include, but is not limited to, a television monitor, a computer monitor, a printer, a facsimile, a speaker, and so on. As used herein, virtual reality, augmented reality, and mixed reality may each be used interchangeably, yet refer to any kind of extended reality, including virtual reality, augmented reality, and mixed reality.

The user devices 140 may each similarly include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the analysis system 110. Therefore, it should be understood that the description of the network interface 112, the processing circuit 114, and the input/output device 132 of the analysis system 110 provided above may be similarly applied to the network interface 142, the processing circuit 144, and the input/output device 160 of each of the user devices 140.

In some embodiments, the network interface 142 is similarly structured and used to establish connections with other computing systems (e.g., the analysis system 110, other user devices 140, and data sources 170) via the network 130. The network interface 142 may further include any or all of the components discussed above, with reference to the network interface 112. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150 (e.g., user device dataset 152). For example, the user devices 140 may be configured to run an application such as the user client application 154 that is stored in the user device dataset 152. In another example, the user devices 140 may be configured to store various user data, such as, but not limited to, personal user device information (e.g., names, addresses, phone numbers, contacts, call logs, installed applications, and so on), user device authentication information (e.g., username/password combinations, device authentication tokens, security question answers, unique client identifiers, biometric data (such as digital representations of biometrics), geographic data, social media data, application specific data, and so on), and user device provider information (e.g., token information, account numbers, account balances, available credit, credit history, exchange histories, and so on) relating to the various accounts.

Particularly, the user client application 154 can be configured to communicate with the analysis system 110. As such, the user devices 140 can be communicably coupled to the analysis system 110 (e.g., through interactions with the modeler circuit 124, data control circuit 126, and content control circuit 128), and data sources 170. The user client application 154 may therefore communicate with the analysis system 110 and data sources 170 to perform a variety of functions. For example, the user client application 154 is similarly configured to receive user inputs (e.g., via a user interface of the user device 140) to complete interactions during a communication session with analysis system 110. For example, the user client application may be used during a communication session via an API with the analysis system 110 to provide performance parameter indications using content items. Additionally, the user client application 154 is configured to output information to a display of user device 140 regarding information received from the analysis system 110. For example, the user client application 154 is configured to communicate with a user interface to show graphics regarding modeled performance products with one or more actionable events. Further, a user response to a display of user device 140 regarding information from the analysis system can send a message, task, or instruction to the analysis system 110 via the network 130 that allows for the modeling dataset 122, modeler circuit 124, data control circuit 126, and/or content control circuit 138 to be perform an update.

The user client application 154 is further configured to communicate with the analysis system 110 to allow a user associated with the various user devices 140 to update account information and/or provide feedback during a communication session based on content from the modeler circuit 124, data control circuit 126, or content control circuit 128 via the input/output device 132. The user client application 154 may also be structured to allow the user devices 140 to perform one-click actions, retrieve and submit documents, forms, account information for other providers, and/or any type of necessary information to and/or from the analysis system 110 during an established session, as required to complete a communication session for a performance indicator-based analysis or update. In some embodiments, the user client application 154 may be configured to temporarily store the various documents, forms, and/or necessary information, which may then be selectively transmitted to the analysis system 110 in response to a user input (e.g., received via the input/output device 160).

The input/output device 160 of each user device 140 may function substantially similar to and include the same or similar components as the input/output device 132 previously described, with reference to the analysis system 110. As such, it should be understood that the description of the input/output device 132 provided above may also be applied to the input/output device 160 of each of the user devices 140. In some embodiments, the input/output device 160 of each user device 140 is similarly structured to receive communications from and provide communications to a user associated the user device 140.

The data sources 170 can provide data to the analysis system 110 and/or user device 140. In some arrangements, the data sources 170 can be structured to collect data from other devices on network 130 (e.g., user devices 140 and/or other third-party devices) and relay the collected data to the analysis system 110 and/or user device 140. In some embodiments, the analysis system 110 may request data associated with specific data stored in the data source (e.g., data sources 170). For example, in some arrangements, the data sources 170 can support a search or discovery engine for Internet-connected devices. The search or discovery engine may provide data from other providers that, when added to a user data structure (e.g., user data structure created by the modeler circuit 124 based on data from the modeling dataset 122) will cause an update to a performance indicator.

In some embodiments, the activity modeler architecture 100 can include provider systems 135. A provider system 135 can be communicated with to obtain or access additional activity data, where the provider system 135 can be banks or other credit issuers (e.g., credit card companies, consumer reporting companies, financial institutions (FI)). In some arrangements, provider systems 135 can provide data to the analysis system 110 and/or user device 140. In some arrangements, a provider system 135 can be structured to collect data from other devices on the network 130 (e.g., user devices 140 and/or other third-party devices) and relay the collected data to the analysis system 110 and/or user device 140. In some embodiments the analysis system 110 may request data associated with specific data stored in the provider system 135. For example, in some arrangements, the provider systems 135 can support a search or discovery engine for Internet-connected devices. The search or discovery engine may provide data from other providers that, when added to user activity data (e.g., a data structure created by the modeler circuit 124 based on data from the modeling dataset 122), will cause an update to a performance indicator.

In some embodiments, the provider system 135 can serve as a basis for the analysis system 110 to provide resource allocation authorizations. For example, a provider system (e.g., provider system 135) can provide user activity data to the analysis system 110. The processing circuit 114 can produce resource allocation authorizations based on data provided by the provider system 135. For example, the analysis system 110 could determine, based on data sent from the provider system 135, that a user is eligible for a line of credit or bundled credit system. In another example, the analysis system 110 could determine, based on data sent from the provider system 135, that a user could perform one or more actions to immediately increase their performance indicator(s). The analysis system 110 could produce a bundled resource authorization that includes new authorization parameters based on the authorization parameters of the provider systems 135.

In some arrangements, resource allocation authorizations are configured permissions by the provider system 135, delineating access to particular financial resources such as credit lines or loans. These authorizations can be defined by detailed parameters such as credit limits, interest rates, repayment terms, or eligibility criteria. Bundled resource authorizations provide a consolidation or combination of various individual authorizations, potentially from different provider systems, and include an alignment of their respective authorization parameters. By leveraging data received from provider systems 135, the analysis system 110 can algorithmically determine a user's eligibility for a line of credit or a bundled credit system, and accordingly, formulate a bundled resource authorization. This process involves an analysis of common and conflicting parameters among the provider systems 135, and generating new authorization parameters that represent an optimized, unified authorization. For example, if the authorization parameters from two different providers allow for a certain credit limit but differ in interest rates, the bundled resource authorization might blend these conflicting parameters to offer a consolidated line of credit with a newly calculated interest rate, in alignment with predefined rules or user preferences.

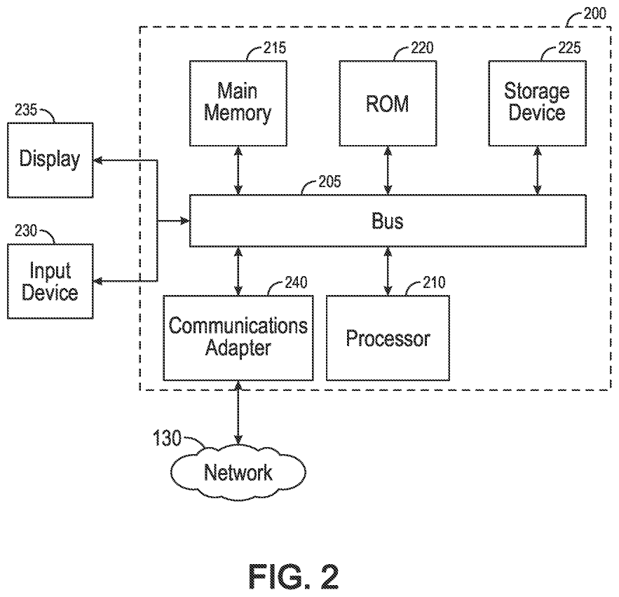

Referring now to FIG. 2, a depiction of a computer system 200 is shown. The computer system 200 that can be used, for example, to implement an activity modeler architecture 100, an analysis system 110, provider systems 135, user devices 140, data sources 170, and/or various other example systems are described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with a computing or communications network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate the illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage mediums for execution by, or to control the operation of, data processing apparatus. Alternatively, or in addition, the program instructions can be encoded on an artificially generated propagated signal, e.g., a machine-generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

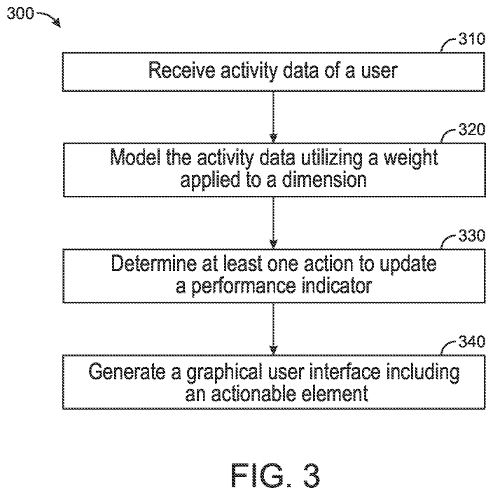

Referring now to FIG. 3, a flowchart for a method 300 of modeling the activities and performance of a user to generate at least one action is shown, according to some embodiments. Analysis system 110 can be configured to perform method 300. Further, any computing device described herein can be configured to perform method 300.

In broad overview of method 300, at block 310, the one or more processing circuits (e.g., analysis system 110 in FIG. 1) can receive activity data of a user. At block 320, the one or more processing circuits can model user activity data utilizing a weight applied to a dimension. At block 330, the one or more processing circuits can determine at least one action to updated a performance indicator. At block 340, the one or more processing circuits can generate and/or present a graphical user interface (GUI) including at least one actionable element. Additional, fewer, or different operations may be performed depending on the particular arrangement. In some embodiments, some or all operations of method 300 may be performed by one or more processors executing on one or more computing devices, systems, or servers. In various embodiments, each operation may be re-ordered, added, removed, or repeated.

The GUI of method 300 may be provided by and/or accessible by the user client application 154 and content control circuit 128, for example. The method 300 may be performed by the analysis system 110 or the user device 140, described above pertaining to FIGS. 1 & 2. In some embodiments, method 300 begins in response to receiving, by a user device (e.g., user device 140), through a user client application (e.g., user client application 154), data from a dataset (e.g., user device dataset 152). The data can include user data, such as historical exchange settlements, performance indicator data, performance product information, actionable events, performance parameters, and activity data. In some embodiments, method begins when the analysis system 110 receives data via the network 130 or identifies data (e.g., locally or externally).

Referring now to FIG. 3 in more detail at block 310, the one or more processing circuits can receive (or identify) activity data of a user, wherein the activity data includes a plurality of dimensions. In some embodiments, the activity data can refer to any and all activity of the user that might be associated with economic actions. In general, the economic actions can be broadly categorized into three types: transactional, behavioral, and informational. In some embodiments, transactional data includes, but is not limited to, all the exchanges/transactions made by the user, such as purchases, payments, fund transfers, deposits, withdrawals, etc., carried out through various channels like banking apps, credit cards, digital wallets, or other forms of online and offline transactions. This also includes transaction frequency, transaction volume, the variety of transactions, the consistency of such transactions over a period of time, etc. In some embodiments, behavioral data includes, but is not limited to, the user's interaction with financial tools and platforms. For example, how frequently the user checks their account balance, the frequency and type of inquiries about financial products or services, the response time to financial notifications, the time spent on financial educational content, etc. In some embodiments, the informational data includes, but is not limited to, the user's personal and professional details, such as age, income, occupation, education, geographical location, marital status, number of dependents, etc.

Still referring to block 310, the process of receiving (or identifying) user activity data can encompass data acquisition, data cleaning, and data classification, executed by the processing circuits. It should be understood one or more of the described steps could be skipped or altered based on the received data. In some embodiments, identifying can include data acquisition by collecting raw data from various sources (e.g., user devices 140, data sources 170, provider systems 135). For example, transactional data can be acquired from providing systems 135 that record the transactions made by the user. Behavioral data can be collected from digital platforms like banking apps or websites (e.g., data sources 170) where the user's interactions are tracked. Informational data can be obtained from user profiles in provider systems 135, or sometimes directly from users via an application of the user device 140. In some embodiments, the activity data further includes timeline data includes a plurality of user actions affecting the performance indicator, and wherein each user action of the plurality of user actions corresponds to a date and a time of the user action, and wherein the user information includes at least one identification number of the user.

In some embodiments, once the raw data is acquired, the processing circuits can clean and prepare the data for modeling (e.g., block 320). The processing circuits can clean or scrub the raw data by executing a series of actions to detect and rectify errors, inconsistencies, and inaccuracies within the data. In particular, cleaning could include handling missing or incomplete data, correcting inaccuracies, identifying and filtering outliers, and standardizing data formats. For example, transactional data sourced from different banks might be in different formats or currencies and would need to be standardized. In another example, data cleaning may include ensuring that credit scores from different credit bureaus are comparable by aligning them to a standard scale. In some embodiments, data cleaning can include addressing discrepancies in informational data. For example, if a user has multiple accounts across different banks or financial institutions, they might have provided slightly different personal information in each account, like different phone numbers or addresses. In such cases, the processing circuits can identify these discrepancies, verify the correct information, and standardize the user's personal information across all data sources. In another example, cleaning the behavioral data might involve filtering out irrelevant or misleading activities. In this example, a user might have accidentally clicked on a financial product or service multiple times without any real intention of using it. These accidental clicks could skew the user's behavioral profile and lead to inaccurate analyses. Therefore, the processing circuits could identify such anomalies and filter them out, ensuring the behavioral data accurately represents the user's genuine financial behavior and interests.

In some embodiments, the processing circuits can execute data classification to organize the cleaned data into predefined (or new) dimensions based on certain criteria. In some embodiments, the activity data may be received already classified into dimensions. In some embodiments, the dimensions of the activity data can relate to the user's activity patterns, diversity of activity types, duration of one or more activities, recent changes in activity habits, and consistency in maintaining the one or more activities. These dimensions, derived from the collected data, help in generating a holistic understanding of the user's financial behaviors and trustworthiness. For example, classifying data under the dimension of “diversity of activity types” could involve determining the various financial behaviors a user engages in, while the dimension “consistency in maintaining activities” could focus on the regularity of bill payments or loan settlements. Through this classification process, the processing circuits can prioritize and weight different dimensions based on their relevance and significance in determining an individual's creditworthiness or financial behavior.

In some embodiments, other dimensions that can be considered when evaluating a user's financial behavior include “Financial Knowledge and Education”, which evaluates the extent of a user's financial literacy based on courses taken, articles read, or seminars attended. Another dimension, “Adaptability to Economic Changes”, could assess how a user adjusts their spending and saving behaviors in response to broader economic trends or personal financial crises. The “Digital Interaction Frequency” dimension might focus on how often a user engages with digital financial platforms versus traditional methods, providing insights into their comfort level with technology and potentially their openness to new financial products or services. Another potential dimension, “Peer Comparisons”, could analyze a user's financial behavior in relation to their peers or a similar demographic group, giving context to their actions and decisions. “Investment Behavior” could be another dimension, looking at not just the amount, but the types of investments a user makes, and how they diversify their portfolio.

In some embodiments, the activity data includes a plurality of math-based currency exchanges between the user and one or more third-parties, and wherein the performance indicator is based at least on the plurality of math currency exchanges, and wherein the plurality of math-based currency exchanges includes metadata including key information of the user, node information corresponding with a computing system of the user, and address information corresponding with the plurality of math-based currency exchanges of the user. Specifically, the activity data includes a multitude of math-based currency exchanges executed between the user and various third-parties. Embedded within the currency exchanges is metadata that can be used for the interpretation and analysis of the user's activity. This metadata can entail specific key information relating to the user, which could be a unique identifier or cryptographic signature that authenticates and preserves the integrity of each transaction. Additionally, the metadata can contain node information, indicative of the user's computing system—this may include system specifications, software versions, or any distinctive attributes that can be mapped back to the origin of the transaction, serving as a crucial element in traceability and security protocols. Furthermore, the metadata provides address information, which correlates with the pathways and destinations of the math-based currency exchanges initiated by the user. This address information, often in the form of cryptographic addresses, delineates the source and target points of each transaction, enabling not only transactional traceability but also facilitating real-time auditing and validation processes.

At block 320, the one or more processing circuits can model the activity data utilizing one or more weights applied to the plurality of dimensions to generate a performance indicator of the user. The performance indicator can be real-time or near real-time economic position or account status of the user, and wherein the performance indicator is updated in response to receiving new activity data. In some embodiments, the process of modeling can include using techniques such as machine learning, statistical analysis, and pattern recognition to establish relationships between different data points and generate performance indicators based on those relationships. In some embodiments, modeling can begin with the selection of an appropriate model based on the type of data and the specific predictions that need to be made. In some embodiments, the processing circuits can utilize pattern recognition methodologies to identify trends and likelihoods of desiring a performance indicator value or score. For example, pattern recognition applied to user activity data can discern cyclical trends in expenditure, identifying increases at the beginning and middle of the month with a decline towards the end. By integrating this trend with historical performance indicators, like credit scores, the processing circuits can generate a performance indicator (e.g., real-time, current performance indicator). In another example, spectral analysis can be utilized to analyze the frequency components embedded within a user's transaction history. In yet another example, linear regression models might be selected by the processing circuits for predicting a performance indicator, while logistic regression models might be selected for predicting an actions such as whether a user will perform an action to increase their performance indicator. It should be understood that the term modeling herein encompasses a wide range of techniques and approaches aimed at understanding patterns within data and generating performance indicators. This could include anything from statistical methods and rule-based systems to machine learning algorithms, depending on the nature of the data and the specific predictions to be made by the processing circuits. Thus, modeling involves selecting techniques based on the specific characteristics of the data, ensuring that the chosen method or methods accurately captures patterns, predicts user activities, and generates performance indicators.

In some embodiments, the utilizing one or more weights applied to the plurality of dimensions can include dynamically adjusting the importance or significance of each dimension based on real-time financial events, market trends, or user-specific changes. The application of these weights can be achieved algorithmically, factoring in historical user data, macroeconomic indicators, and potential financial market shifts. For example, during an economic downturn, the weight associated with a user's “Adaptability to Economic Changes” might be increased, as it would be important to assess how users adjust to new financial challenges. Conversely, during stable economic conditions, the weight for “Consistency in Transactions” might be given more emphasis. This dynamic weighting approach ensures that the performance indicator remains relevant and adaptive to both broader economic contexts and individual user behaviors.

In some embodiments, the value of a dimension can be determined by aggregating individual data points within that dimension using methods like averaging or summing. In other embodiments, machine learning algorithms or statistical methods may analyze the user's historical data within the dimension to assign a predictive score. In yet another embodiment, the dimension value might be established based on a user's rank or percentile when compared to a broader population or benchmark. In some embodiments, for the dimension “Consistency in Transactions,” the value can be derived by calculating the average percentage of on-time payments made by the user over the past 12 months. For example, if a user made 10 monthly payments, of which 9 were on time, the value for this dimension would be 90%. In another embodiment, for the dimension “Diversity of Activity Types,” a value might be assigned by counting the number of distinct financial activities the user engages in. If a user maintains 2 checking accounts, has applied for 3 different types of loans, and uses 2 distinct credit cards, the total count would be 7, and this value could be benchmarked against averages or thresholds set by the financial institution. In some embodiments, the plurality of dimensions include data elements of user's activity patterns, diversity of activity types, duration of one or more activities, recent changes in activity habits, and consistency in maintaining the one or more activities, wherein each dimension of the plurality of dimensions corresponding to a distinct weight of the one or more weights in generating the performance indicator.

In some embodiments, the performance indicator can be a quantitative value representing the activity data of the user, and wherein the performance indicator further includes at least one of a performance consistency sub-indicator or a performance duration sub-indicator (e.g., value between 0 and 10, value between 0 and 100, percentage value, etc.). In some embodiments, the performance consistency sub-indicator is a first measurement of the user maintains one or more performance obligations over a future time period, and wherein the performance duration is a second measurement over a previous time period that the user has maintained positive performance indicator behavior or positive performance indicator history. Specifically, the performance consistency sub-indicator is primarily designed to predict future reliability based on the historical and real-time data of a user. It employs algorithms that weight recent behavior more heavily, recognizing that recent actions may be a more accurate representation of future actions. Factors such as frequency, magnitude, and regularity of past transactions or exchanges can be incorporated to provide a probabilistic assessment of how consistently a user will adhere to predefined performance obligations. The performance consistency sub-indicator provides insights into a user's potential behavior, gauging the likelihood of them maintaining their obligations in a forthcoming time frame. This sub-indicator uses predictive analytics, leveraging machine learning techniques or other modeling techniques to analyze patterns in the user's activity data. By examining the variance in their historical data and comparing it against established benchmarks or norms, the consistency sub-indicator produces a value that represents the user's stability and reliability in performance. For example, if a user consistently fulfills transactions on time or exceeds certain thresholds in activity, the performance consistency sub-indicator would reflect a higher value, indicating robustness and dependability in their behavior.

In some embodiments, the performance duration sub-indicator can be directed to assessing the longevity of a user's positive performance behavior or history. This is important in establishing a user's credibility, especially in scenarios where long-term reliability is important. By analyzing the timespan over which a user has sustained positive activity, this sub-indicator provides a historical perspective on the user's commitment and consistency. The algorithm evaluates the length of time during which the user has upheld their performance criteria, factoring in the intensity and frequency of positive behaviors. If a user has a prolonged history of adhering to performance metrics without significant deviations or negative events, the performance duration sub-indicator would denote a higher value, signifying that the user has a proven track record of maintaining their performance standards over extended periods.

For example, Jane over the past 12 months could have engaged in 130 math-based currency exchanges with various third-parties. In this time frame, she maintained a transaction consistency of 9.8, implying she met her performance obligations on time for 98% of these specialized exchanges. This results in a performance consistency sub-indicator value of 9.8. Analyzing her performance duration sub-indicator, which assesses her positive behavior over the past 5 years, reveals she upheld an average of 9.6 adherence to her performance obligations for these transactions. Thus, she achieves a performance duration value of 9.6. In another example, John primarily engages in traditional financial transactions. In the last year, he undertook 150 regular exchanges with third-parties. His consistency in fulfilling obligations timely stood at 9.3, attributing him a performance consistency sub-indicator of 9.3. Evaluating his five-year track record, the performance duration sub-indicator shows an average of 9.4 reliability in upholding his obligations. In this example, for Jane, the sub-indicator could be used to focus on increasing the frequency of her math-based currency transactions while ensuring they are timely which could boost her overall performance indicator. On the other hand, John might benefit from an action that indicates he should diversify his transaction types and work on improving the consistency of his regular exchanges. The sub-indicators, by offering insights into areas of strength and potential improvement, serve as actionable blueprints that can guide (i.e., with actions) users like Jane and John toward optimizing their primary performance indicator: their performance indicator.

In some embodiments, the modeling process integrates the weights of dimensions by scaling and prioritizing specific data points or categories, ensuring that the performance indicator is both a true representation of the data and reflective of each dimension's significance in predicting creditworthiness or other outcomes. In some embodiments, the process can begin by applying vector multiplication, wherein each data point within a dimension is multiplied by its respective weight. This method effectively scales the data point, ensuring that those within highly weighted dimensions exert a more substantial influence on the final performance indicator. For instance, if the “Consistency in Transactions” dimension has a weight of 0.8 and a user has a consistency score of 9, the weighted score becomes 7.2. Furthermore, during the modeling phase, machine learning algorithms or statistical models might use these weighted inputs to train or calibrate themselves. Additionally, in situations where dimensions interact or correlate, the modeling could incorporate multidimensional scaling. Here, the combined effect of two or more weighted dimensions is considered, possibly revealing insights not evident when analyzing dimensions in isolation. For example, a user's “Financial Knowledge and Education” dimension might influence how they score in “Adaptability to Economic Changes”. When modeling, their combined weighted scores might provide a more accurate representation of a user's credit risk than when evaluated separately. In the context of deriving sub-indicators like performance consistency and performance duration, dimension weights can also be used. By integrating these weights, the modeling process can accurately quantify the reliability of a user over different time frames and in varying transaction scenarios. The weighted value of a dimension, for example “Frequency of Transactions”, might impact the performance consistency sub-indicator more directly, as it determines how regularly a user engages in transactions. Conversely, the “History of Performance” dimension, when weighted appropriately, would significantly influence the performance duration sub-indicator, which gauges long-term reliability.

In some embodiments, the performance indicators of a user are associated with the creditworthiness of the user. This can be determined by the one or more processing circuits through utilizing one or more weights applied to the plurality of dimensions and various metrics of activity data such as credit score, credit history, debt-to-income ratio, and so on. In particular, a performance indicator can be a numerical expression based on a level analysis of a person's credit files, representing the creditworthiness of an individual. Related scores (e.g., additional performance indicators) could include alternative credit scores, which can be identified or calculated using non-traditional data like utility bill payments, rental payments, or social media activity. Additionally, performance indicators can include a bankruptcy risk score, which predicts the probability of a user declaring bankruptcy, and a fraud score, which indicates the likelihood of a user committing fraudulent activity.

In some embodiments, alternatives to traditional credit scores may be used as performance indicators to provide a more comprehensive and nuanced understanding of a user's financial standing. These alternatives can incorporate unconventional data and behavior patterns that might not be reflected in a standard credit score. For example, performance indicators could include an employment stability score, assessing the consistency and longevity of a user's employment history; a financial behavior score, based on spending habits, savings, and investment decisions; or a social responsibility score, reflecting a user's commitments to charitable donations or community engagement. Additionally, a payment consistency score might be used, tracking the regularity and punctuality of payments across various obligations such as subscriptions, memberships, or informal debt agreements. An interest rate change score might also be utilized, which evaluates the user's responsiveness and adaptability to fluctuations in interest rates, potentially influencing their ability to manage loans and credit lines. These alternative performance indicators can offer a perspective on the user's financial reliability, potentially benefitting individuals who may be disadvantaged by traditional credit scoring methods.

In some embodiments, the model parameters can be trained and optimized using the cleaned, classified, and linked activity data and applying one or more weights to the plurality of dimensions. This training process can include using algorithms to adjust the model parameters such that the error between the model's predictions and the actual outcomes is minimized. The modeling process can also include feature engineering, which is the process of creating new features or modifying existing ones to improve the model's predictive power. For example, instead of using raw transaction amounts, a feature representing the average transaction amount over a certain period might be more predictive of a user's performance indicator.

In some embodiments, the processing circuits can use rule-based systems to model the user activity data. Rule-based systems can be where predefined rules are created by the processing circuits (or domain experts) to infer outcomes based on given conditions. For example, if a user consistently makes credit card payments in full before the due date, a rule might state that the user is likely to do the same in the future. This rule can then be applied to the user's data and weighted to generate a performance indicator. In some embodiments, the processing circuits can use statistical methods for modeling. This can involve approaches like time series analysis or trend analysis. For example, time series analysis can be used to identify patterns in the user's past activity data, such as seasonal trends, cyclical patterns, or overall growth trends. If a user consistently increases their credit card spending during the holiday season, time series analysis can identify this pattern and predict a similar increase for the next holiday season. Trend analysis, on the other hand, can be used to identify long-term changes in the user's activity data (e.g., for predict a future performance indicator). For example, if the user's performance indicator has been steadily improving over several years, trend analysis can project this trend into the future and predict a continued improvement in the credit score (e.g., stored within the activity data).

Accordingly, the processing circuits can use a predictive modeling approach to generate performance indicators for a user. Additionally, the modeling approach operates agnostically of the financial institution providing the service, offering an integrated and full view of a user's financial commitments. Furthermore, the predictive modeling approach executed by the processing circuits can detect seasonal or event-based patterns in the user's spending and behaviors (sometimes referred to herein as “characteristics”). If, for example, the user typically increases credit card spending during holiday seasons, the model can anticipate higher bill amounts during these periods (e.g., stored within the user activity data).

Referring now to FIG. 3 in more detail at block 330, the one or more processing circuits can determine at least one action corresponding to updating the performance indicator. After the activity data is modeled to generate a real-time performance indicator (e.g., a real-time credit score or economic indicator), the one or more processing circuits determine immediate actions that a user can execute to enhance this score. Leveraging algorithms and real-time data analytics, the processing circuits can identify specific financial actions with the potential for immediate impact. For example, the processing circuits may recognize that paying off a recently incurred high-interest debt can lead to a significant boost in the user's credit score. In another example, the processing circuits might advise the user to rectify any inaccuracies in their credit report, as resolving these discrepancies can lead to immediate improvements. The determined actions are not only based on their potential impact but also on the feasibility of executing them swiftly, such as settling a small outstanding balance or transferring a balance to a card with a lower interest rate. After determining these immediate actions, the processing circuits may further provide suggestions based on performance sub-indicators to offer a holistic approach to credit enhancement, ensuring the user has a comprehensive roadmap to financial improvement.

In some embodiments, the processing circuits might directly compare the user's credit utilization to threshold values, suggesting actions like paying down balances on maxed-out credit cards to immediately improve the performance indicator. The processing circuits could also identify high-interest debts in the user's profile and recommend immediate payments to reduce overall financial burden, thus positively affecting the performance indicator. Additionally, by tracking recent credit inquiries, the processing circuits can advise the user to refrain from applying for new credit, as multiple inquiries in a short span can negatively impact the performance indicator. Additionally, at block 330, the one or more processing circuits can employ algorithms to analyze the user's real-time performance indicator derived from the modeled activity data. Using regression models, the processing circuits can predict the potential increase in performance indicator based on variables like credit utilization rate, debt-to-income ratio, and recent credit inquiries. Decision trees segment users based on credit behavior patterns, tailoring actionable recommendations. Matrix factorization techniques identify latent factors in the user's credit history, pinpointing non-obvious actions that can influence the performance indicator. Through time series analysis, the algorithms assess temporal dependencies, indicating which actions could provide immediate performance indicator improvements.

Accordingly, the identified actions are designed for instantaneous execution, either by the user or the processing circuits, to effect an immediate uplift in the credit score. This real-time adjustment capability contrasts with traditional methods that typically involve longer-term behavioral changes. By leveraging real-time data analytics, the processing circuits empowers users to enhance their credit scores promptly. For example, if the action involves transferring funds to offset a high-interest debt, the processing circuits could facilitate that transfer instantly upon user confirmation. Similarly, if the identified action is to consolidate multiple debts into one with a lower interest rate, the processing circuits could automate the loan application and approval process, subject to user approval, thereby immediately improving the user's credit utilization ratio and subsequently, their credit score. This immediacy and automation in action execution are central to providing users with tangible, real-time benefits in their financial health metrics.

In some embodiments, the at least one action corresponds to either closing a first performance product and enrolling in a second performance product or transferring the first performance product to the second performance product. For example, one of the immediate actions that the processing circuits might suggest to enhance a user's performance indicator is related to the management of these performance products. Specifically, the processing circuits might identify that a user could benefit from closing a first performance product (e.g., a high-interest credit card) and enrolling in a second, more advantageous performance product, such as a credit card with lower interest rates or better rewards. Alternatively, it could be more beneficial for the user to transfer the balance or the attributes of the first performance product to the second one. For example, if the user has a credit card with a high utilization rate, transferring the balance to a new card with a higher credit limit could reduce the utilization ratio, thereby offering an immediate positive impact on the performance indicator. Similarly, swapping a high-interest loan for one with a lower interest rate could lead to savings and better creditworthiness metrics. Such actions can serve as real-time strategies to enhance the user's credit score.

Referring now to FIG. 3 in more detail at block 340, the one or more processing circuits can generate and provide (or present) a graphical user interface (GUI) including actionable elements and at least one graphical representation of the performance indicator, wherein the actionable elements are associated with the at least one action. For example, an actionable element can refer to making a payment, automating future payments, remediating past payments, remediating past missed payments, consolidating lines of credit, generating a reward, performing a fraud check on exchanges, generating a notification, registering a new account or line of credit, paying a minimum, or other user activities. In another example, an actionable element can refer to initiating a financial danger assessment, tailoring personalized financial products, or restructuring existing financial arrangements in alignment with the user's current financial standing. As such, the actionable element can be one or more activities the user or computing systems can execute or perform to reach or increase a performance indicator. In general, some or more actionable elements can be configured to attempt to improve (e.g., if executed or performed) one or more performance indicators of the user (e.g., to qualify for a performance product) in real-time, using a single action (e.g., selecting the actionable element). In some embodiments, the actionable elements correspond to the future activity of the user.

In some embodiments, GUI is generated and presented to depict a performance indicator the user could obtain based on an action. The GUI can present the action to take, an actionable element to initiate that action (e.g., by the processing circuits, by the user, or a combination thereof). In some embodiments, at least one of the actionable elements, upon an input by the user, initiates and executes the at least one action to update the performance indicator, wherein execution of the at least one action updates the performance indicator instantaneously or approximately thereafter. The GUI can include a description of the at least one action, a button or another type of actionable element to update the performance indicator based on initiating and executing the at least one action, and a new performance indicator.

For example, the GUI might include a real-time performance indicator of 650 and a new expected performance indicator of 670, with an actionable button labeled “Consolidate Credit Card Debt.” By clicking on this button, the user initiates the action of consolidating multiple high-interest credit card debts into a single lower-interest loan. Once this action is executed, either automatically by the processing circuits or with minimal user input, the performance indicator on the GUI updates to reflect a new, improved credit score of 670. In another example, the GUI may include an actionable element labeled “Remediate Missed Payments,” positioned with a performance indicator showing a credit score of 580 and a new expected credit score of 640. Upon selecting this actionable element, the processing circuits might guide the user to address any outstanding missed payments and/or set up automated payments to prevent future lapses. After the user completes the recommended actions, the credit score on the GUI could adjust, displaying an enhanced score of 610 due to the rectified payment behavior. In yet another example, the interface presents a user with a credit score of 700 and an actionable element titled “Register for Low-Interest Credit Line.” The user can click on the actionable element, and the processing circuits could automatically enroll the user in a new, favorable credit line. As a result, the displayed credit score on the GUI increases to 715, representing the potential advantages of having a diverse credit portfolio and the positive ramifications of the newly added credit line.

Referring now to FIG. 4A, an illustration of a configuration of a user interface 400 on user device 140 is shown. The user interface 400 may be presented within the user client application 154. In some embodiments, the user interface 400 is generated and provided by the content control circuit 128. The content can contain an actionable element (e.g., activity or action). In some embodiments, the user interface 400 may contain one or more actionable (or interactable) buttons or items (e.g., 401 and 402) that influences an actionable activity (e.g., selection an action or perform an action to update a performance indicator). In general, the user interface 400 of FIG. 4A depicts a one-click action (e.g., “Improve Performance Indicator”, i.e., actionable element 402) that, upon selection, the processing circuits can initiate and/or perform the action to improve the current performance indicator (e.g., 682) to a new expected performance indicator (e.g., 716). In some embodiments, the new expected performance indicator may not be equal to the new performance indicator after the action is performed. This disparity can arise due to various reasons, such as sudden changes in the external credit environment, unexpected user actions post the initial assessment, or a miscalculation in the prediction algorithms. Additionally, real-time financial fluctuations or a user's immediate financial activities that were not factored into the initial action might lead to a difference between the anticipated and actual updated performance indicators. Additionally, the user can select alternative action button (i.e., actionable element 401) to be presented with additional one-click opportunities to update their performance indicator.

Referring now to FIG. 4B, an illustration of a configuration of a user interface 400 on user device 140 is shown. The user interface 400 may be presented within the user client application 154. In some embodiments, the user interface 400 is generated and provided by the content control circuit 128. The content can contain an actionable element (e.g., activity or action). In some embodiments, the user interface 400 may contain one or more actionable (or interactable) buttons or items (e.g., 404) that influences an actionable activity (e.g., selection an action or perform an action to update a performance indicator). In general, the user interface 400 of FIG. 4B depicts a one-click action (e.g., “TAP”, i.e., actionable element 404) that, upon selection, the processing circuits can initiate and/or perform the action to improve the current performance indicator. As shown, the action could be a balance transfer from a first provider to a second provider. In some embodiments, the sub-performance indicators could also be depicted. For example, the performance history can include a consistency sub-indicator (e.g., indicated as High-8), and a duration sub-indicator (e.g., indicated as short-2). In this example, it should be understood that the sub-indicators can be a value between 0 and 10 (or another range). For example, values can range from Low (1-2), Middle (3-6), to High (7-10) and for duration, values can span from Short (1-3), Middle (4-7), to Long (8-10). These sub-indicators can provide users with a finer granularity of their performance attributes and allow them to understand specific areas of strength or potential improvement.

Referring now to FIG. 4C, an illustration of a configuration of a user interface 400 on user device 140 is shown. The user interface 400 may be presented within the user client application 154. In some embodiments, the user interface 400 is generated and provided by the content control circuit 128. The content can contain an actionable element (e.g., activity or action). In some embodiments, the user interface 400 may contain one or more actionable (or interactable) buttons or items (e.g., 406) that influences an actionable activity (e.g., selection an action or perform an action to update a performance indicator). In general, the user interface 400 of FIG. 4C depicts a one-slide action (e.g., sliding the bar from no plan to the other plans, i.e., actionable element 406) that, upon selection, the processing circuits can initiate and/or perform the action to improve the current performance indicator and initiate the plan. As shown, each plan can update the performance indicator upon sliding the one-slide action to a plan, and each plan be presented with a line graph of how the performance indicator would increase over time upon initiating the plan, and each performance indicator strategies (e.g., Plan 1, Plan 2, Plan 3, etc.) could be presented with the strategies to perform the plan (e.g., Plan 1 can have strategy X, strategy Y, and strategy Z). For example, in response to sliding the actionable element 406 to plan on the sliding scale, the processing circuits can initiate and perform Plan 1, which includes an initial action to increase their performance indicator (e.g., consolidating outstanding debts) and then perform additional strategies to increase their performance indicator over time (e.g., setting up regular savings and improving credit utilization). In some embodiments, the user can interact with the line graph or performance indicator strategies by selecting points on the line graph or selecting the arrow indicators to look through the plans. For example, selecting a point on the line graph might provide detailed insights into specific actions or events that contribute to a projected spike in the performance indicator, while tapping on the arrow indicators might cycle through different strategies corresponds to different plan, highlighting their individual impacts on the performance trajectory.

Referring now to FIG. 4D, an illustration of a configuration of a user interface 400 on user device 140 is shown. The user interface 400 may be presented within the user client application 154. In some embodiments, the user interface 400 is generated and provided by the content control circuit 128. The content can contain an actionable element (e.g., activity or action). In some embodiments, the user interface 400 may contain one or more actionable (or interactable) buttons or items (e.g., 408) that influences an actionable activity (e.g., selection an action or perform an action to update a performance indicator). In general, the user interface 400 of FIG. 4D depicts a one-click action (e.g., “Improve Performance Indicator”, i.e., actionable element 408) that, upon selection, the processing circuits can initiate and/or perform the action to improve the current performance indicator (e.g., 722) to a new expected performance indicator (e.g., 728). As shown, the action includes implementing security measures. In some embodiments, the processing circuits can implement security measures on the user device 140 or other systems or services of the user to improve their performance indicator immediately or approximately in real-time. For example, one security measurement implementation to the user device 140 to improve the performance indicator of the user could be the activation of two-factor authentication for all linked financial accounts, enhancing the security and reducing the risk of unauthorized access. In another example, one security measurement implementation to the user device 140 to improve the performance indicator of the user could be the installation and activation of a real-time fraud detection software, which monitors and alerts the user to any suspicious activities related to their financial data. In yet another example, one security measurement implementation to a service of the user to improve the performance indicator of the user could be the encryption of sensitive data stored in a cloud-based financial management platform, ensuring data privacy and integrity.

Referring now to FIG. 4E, upon the user selecting the actionable element 408, a pop-up 410 may be depicted on the user interface, presenting a prompt that reads something akin to “The Provider would like to modify your security controls. Do you allow these changes?” with options for the user to select either “OK” or “Don't Allow”. If the user opts for “OK’”, the processing circuits could then initiate a secure connection (e.g., utilizing the Transport Layer Security (TLS) protocol) to the target system, be it the user's device 140 or a remote service. Utilizing pre-defined scripts and API calls, the processing circuits would request authentication permissions to implement the desired security measures. For the activation of two-factor authentication, the processing circuits would interface with the user authentication system or module of the target system and enable the two-factor mechanism, potentially sending an initial verification code to the user to confirm setup. Should the user select the fraud detection software, the processing circuits could fetch the appropriate installation package from a trusted repository, initiate its installation on the user device 140, and upon successful installation, activate its real-time monitoring features, updating relevant configurations. For the encryption of data on cloud platforms, the processing circuits would interface with the platform's data storage APIs, retrieve sensitive data blocks, encrypt them utilizing robust encryption algorithms like AES-256, and then re-upload the encrypted data back to the cloud. If “Don't Allow” is selected, the process would be aborted, ensuring user agency in the decision-making process. Accordingly, enhancing security measure can directly and immediately boost a user's performance indicator based on their commitment to safeguarding personal and financial data.

It should be understood that no claim element herein is to be construed under the provisions of 35 U.S.C. § 112(f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A system comprising:
a processing circuit comprising memory and one or more processors, the processing circuit configured to:
receive activity data of a user, wherein the activity data comprises a plurality of dimensions;
model the activity data utilizing one or more weights applied to the plurality of dimensions to generate a performance indicator of the user;
determine at least one action corresponding to updating the performance indicator; and
generate and provide a graphical user interface (GUI) comprising an actionable element and at least one graphical representation of the performance indicator, wherein the actionable element is associated with the at least one action.

2. The system of claim 1, wherein the performance indicator is a quantitative value representing the activity data of the user, and wherein the performance indicator further comprises at least one of a performance consistency sub-indicator or a performance duration sub-indicator.

3. The system of claim 2, wherein the performance consistency sub-indicator is a first measurement of the user maintaining one or more performance obligations over a future time period, and wherein the performance duration sub-indicator is a second measurement over a previous time period that the user has maintained positive performance indicator behavior or positive performance indicator history.

4. The system of claim 1, wherein the activity data further comprises timeline data comprising a plurality of user actions affecting the performance indicator, and wherein each user action of the plurality of user actions corresponds to a date and a time of the user action, and wherein the timeline data comprises at least one identification number of the user.

5. The system of claim 1, wherein the plurality of dimensions comprises data elements of the user's activity patterns, diversity of activity types, duration of one or more activities, recent changes in activity habits, and consistency in maintaining the one or more activities, wherein each dimension of the plurality of dimensions corresponding to a distinct weight of the one or more weights in generating the performance indicator.

6. The system of claim 1, wherein the actionable element comprises a plurality of actionable elements, and wherein at least one of the actionable elements, upon an input by the user, initiates and executes the at least one action to update the performance indicator, wherein execution of the at least one action updates the performance indicator instantaneously or approximately thereafter.

7. The system of claim 1, wherein the GUI further comprises:
a description of the at least one action;
a button to update the performance indicator based on initiating and executing the at least one action; and
a new performance indicator.

8. The system of claim 1, wherein the performance indicator is a real-time or near real-time economic position or account status of the user, and wherein the performance indicator is updated in response to receiving new activity data.

9. The system of claim 1, wherein the activity data comprises a plurality of math-based currency exchanges between the user and one or more third-parties, and wherein the performance indicator is based at least on the plurality of math-based currency exchanges, and wherein the plurality of math-based currency exchanges comprises metadata comprising key information of the user, node information corresponding with a computing system of the user, and address information corresponding with the plurality of math-based currency exchanges of the user.

10. The system of claim 1, wherein the at least one action corresponding to either closing a first performance product and enrolling in a second performance product or transferring the first performance product to the second performance product.

11. A method comprising:
receiving, by one or more processing circuits, activity data of a user, wherein the activity data comprises a plurality of dimensions;
modeling, by the one or more processing circuits, the activity data utilizing one or more weights applied to the plurality of dimensions to generate a performance indicator of the user;
determining, by the one or more processing circuits, at least one action corresponding to updating the performance indicator; and
generating and providing, by the one or more processing circuits, a graphical user interface (GUI) comprising an actionable element and at least one graphical representation of the performance indicator, wherein the actionable element is associated with the at least one action.

12. The method of claim 11, wherein the performance indicator is a quantitative value representing the activity data of the user, and wherein the performance indicator further comprises at least one of a performance consistency sub-indicator or a performance duration sub-indicator.

13. The method of claim 12, wherein the performance consistency sub-indicator is a first measurement of the user maintaining one or more performance obligations over a future time period, and wherein the performance duration sub-indicator is a second measurement over a previous time period that the user has maintained positive performance indicator behavior or positive performance indicator history.

14. The method of claim 11, wherein the activity data further comprises timeline data comprising a plurality of user actions affecting the performance indicator, and wherein each user action of the plurality of user actions corresponds to a date and a time of the user action, and wherein the timeline data comprises at least one identification number of the user.

15. The method of claim 11, wherein the plurality of dimensions comprises data elements of the user's activity patterns, diversity of activity types, duration of one or more activities, recent changes in activity habits, and consistency in maintaining the one or more activities, wherein each dimension of the plurality of dimensions corresponding to a distinct weight of the one or more weights in generating the performance indicator.

16. The method of claim 11, wherein the actionable element comprises a plurality of actionable elements, and wherein at least one of the actionable elements, upon an input by the user, initiates and executes the at least one action to update the performance indicator, wherein execution of the at least one action updates the performance indicator instantaneously or approximately thereafter.

17. The method of claim 11, wherein the GUI further comprises:
a description of the at least one action;
a button to update the performance indicator based on initiating and executing the at least one action;
a new performance indicator; and
wherein the performance indicator is a real-time or near real-time economic position or account status of the user, and wherein the performance indicator is updated in response to receiving new activity data.

18. The method of claim 11, wherein the activity data comprises a plurality of math-based currency exchanges between the user and one or more third-parties, and wherein the performance indicator is based at least on the plurality of math-based currency exchanges, and wherein the plurality of math-based currency exchanges comprises metadata comprising key information of the user, node information corresponding with a computing system of the user, and address information corresponding with the plurality of math-based currency exchanges of the user.

19. The method of claim 11, wherein the at least one action corresponding to either closing a first performance product and enrolling in a second performance product or transferring the first performance product to the second performance product.

20. One or more non-transitory computer-readable storage media having instructions stored thereon that, when executed by at least one processing circuit, causes the at least one processing circuit to:
receive activity data of a user, wherein the activity data comprises a plurality of dimensions;
model the activity data utilizing one or more weights applied to the plurality of dimensions to generate a performance indicator of the user;
determine at least one action corresponding to updating the performance indicator; and
generate and provide a graphical user interface (GUI) comprising an actionable element and at least one graphical representation of the performance indicator, wherein the actionable element is associated with the at least one action.
